(19) United States
(12) Patent Application Publication
(10) Pub. No.: US 2026/0042094 A1
(43) Pub. Date: Feb. 12, 2026

(54) PARTICLE GUIDING GROOVE

(71) Applicant: VRIJE UNIVERSITEIT BRUSSEL, Brussel (BE)

(72) Inventors: Wim DE MALSCHE, Berchem (BE); Iwona ZIEMECKA, Grez-Doiceau (BE)

(21) Appl. No.: 19/099,990

(22) PCT Filed: Jul. 28, 2023
(86) PCT No.: PCT/EP2023/071054

§ 371 Date: Jan. 30, 2025

(30) Foreign Application Priority Data
Aug. 1, 2022 (EP) 22188181.6

(51) Int. Cl. B01L 3/00

(52) U.S. Cl. CPC B01L 3/502761; B01L 2200/0647; B01L 2300/0851; B01L 2400/086

(57) ABSTRACT

A microfluidic device and method for allowing particles to interact with a plurality of liquids are provided. The microfluidic device includes a microfluidic channel having a bottom wall, a plurality of inlets for introducing the plurality of liquids in the microfluidic channel so as to create a plurality of parallel fluid flows in the microfluidic channel along a flow direction and an inlet for introducing dispensed particles in the microfluidic channel. The microfluidic device also has a particle guiding groove for inducing lateral movement of the particles in the microfluidic channel so that the particles are guided laterally by the particle guiding groove with respect to the average flow direction in the microchannel, so that the particles are guided through different liquids of the plurality of liquids.

### TECHNICAL FIELD OF THE INVENTION

The present invention relates to the field of microfluidics. In particular, the present invention relates to a microfluidic device and method for manufacturing, coating or inducing reaction processes to particles by sequentially contacting the particles with multiple liquids.

### BACKGROUND OF THE INVENTION

The ability to manipulate microparticles is important for many applications in engineering, chemistry, biology, and physics. Various applications require particle processing, sorting, or self-assembly. Designing advanced materials requires the use of deposition processes on particles in order to produce complex, nanostructured building blocks. One of the deposition techniques that is very popular nowadays is Layer-by-Layer assembly (LbL). This method has many advantages: simple preparation, safe process, versatility, enhancement of material properties, control over material structure, porosity, robustness, possibility of high load of biomolecules in the films. The LbL method received considerable attention in engineering and biomedical fields and is applied for example in drug delivery, integrated optics, sensors and friction reducing coatings. In the classical LbL method, thin films are formed by subsequent deposition of oppositely charged polyelectrolytes (polymer electrolytes) on a substrate of any shape, resulting in polyelectrolyte multilayers. Adsorption of the film is mainly a result of electrostatic interactions occurring between polycationic and polyanionic electrolytes. The layer can be achieved in different ways, for example by dip coating, spin-coating, spray-coating. Automation of LbL processes using conventional macro-scale reactors is highly desirable but difficult to implement. It is time consuming, and non-continuous processes generally require heavy and expensive equipment. Moreover, often problems as non-uniformity and aggregation of microcapsules are encountered, and this requires the application of downstream processing steps like centrifugation, washing and re-suspension. Also, consumption of reagents is higher in batch processes, which can be an important factor when e.g. an expensive drug is involved.

Handling of particles is essential in particle manufacturing approaches. Among many available techniques, optical tweezers are remarkably powerful to manipulate individual objects. An optical tweezer uses forces exerted by a strongly focused beam of light to trap and move particles ranging in size from tens of nanometers to tens of micrometers. Optical tweezers are used to organize planar assemblies of colloidal particles, but also to construct optical pumps and valves built of colloidal particles in microfluidic channels activated with optical tweezers. Another technique to manipulate particles uses sound waves requiring a lower power density than optical tweezers. An acoustic device, based on standing surface acoustic waves that can trap and manipulate single microparticles with real-time control can be used for this. Continuous flow acoustic standing waves are used for the separation of particles in a size range of tens of nanometers to tens of micrometers. Acoustic tweezer technology facilitates particle focusing, separation, alignment, and patterning.

Magnetic particles can be manipulated in microfluidic channels with the use of magnetic fields. Magnetism has been used in microfluidics for actuation, manipulation and detection. The forces involved in micro-magnetofluidics have been extensively described and are generally well understood. Many applications have been developed so far, with as a prominent example the continuous flow magnetic separation of particles and cells.

The above-described technologies, based on optics, acoustics, or magnetism, require additional, sometimes very expensive equipment. There are also methods relying on inertial effects or on guiding structures, with the channel and functional structure design as the critical element that enables particle manipulation.

Inertial microfluidics uses fluid inertia for enhancing mixing and inducing particle separation and focusing. By integration curved (e.g. spiral) channels, inertial microfluidics can be used for continuous separation of particles based on size. Methods to control the motion of microparticles in microfluidic devices have already been extensively studied and reported.

Sangupta et al. in Soft Manner (2013) 9 p 7251 noticed that colloid particles can follow lines (grooves) in a microfluidic chip. These defects lines were random and not deliberately designed trajectory lines. Others focused on controlling the trajectory of the particles in microfluidic chip using designed guiding structures. Park et al. IN Lab Chip (2009) 9 p 2169 studied the ability to sort tailored particles that fit the rail only if they have a specific orientation. The concept of rails for specially designed particles was also used not only to guide them but also to assemble them on chip, as discussed by Chung et al. in Nature Matrerials (2008) 7 p 581 and Lab Chip (2009) 9 p 2845.

More diversity in guiding structures can be found with the application to manipulate liquid droplets. In Lab Chip (2011) 11 p 1030, Kantak et al. imposed droplet trajectories by obstacles to coat droplets LbL on chip. Another method was developed for droplets. Droplets were confined by a channel roof and trapped and guided by rails and anchors that were etched to the channel top surface. To reduce their surface energy, they enter a local depression, as described by Abbyad et al. in Lab Chip (2011) 11 p 813. In Lab Chip (2011) 11 page 3915, Ahn et al. presented a simple method of guiding, distributing, and storing of a train of droplets by using side flows, cavity guiding tracks, and storage chambers. Rail structures were also used for sorting of gas bubble in liquid, as described by Franco-Gomez et al. in Soft Matter, (2017) 13 p 8684.

Another method involves magnetic interaction. Ferromagnetic rails are used to locally create magnetic potential wells. When the field is turned off, the magnetic droplets follow the liquid flow. By switching on the magnetic field, droplets experience a magnetic force that affects their trajectory when passing over the magnetized rail, as described by Teste et al. in Microfluid Nanofluid (2015) 19 p 141. A combination of active laser (optical) manipulation and passive manipulation by the structures like rails and anchors was used in microfluidics to pattern 2D arrays with droplets in a highly selective manner, as described by McDougal et al. in Proc. Of SPIE (2011) p 8097.

There is, thus, still a need in the art for devices and methods that address at least some of the above problems.

### SUMMARY OF THE INVENTION

It is an object of the present invention to provide a good microfluidic device and corresponding method for manufacturing particles, coating particles or inducing reaction processes to particles by contacting the particles sequentially with multiple fluids.

It is an advantage of embodiments of the present invention that systems and methods are provided allowing to transport particles across two or more co-flowing streams without substantially disturbing the interface between the streams.

It is an advantage of embodiments of the present invention that methods and systems are provided for laterally directing particles that are little or not sensitive to fouling.

It is an advantage of embodiments of the present invention that methods and systems are provided for laterally directing particles that are little or not sensitive to blocking of the microfluidic device.

It is an advantage of embodiments of the present invention that methods and systems are provided that can be used with any type of particles, e.g. in contrast to for example systems relying on magnetism for driving magnetic particles back and forth.

It is an advantage of embodiments of the present invention that it allows for easy multi-layer coating, in contrast to at least some of the prior art techniques requiring a number of consecutive batch steps. It is an advantage that a particle guiding groove, as used in embodiments of the present invention, can advantageously be used for contacting particles with multiple liquids running in parallel, thus allowing multi-layer coating in an efficient way.

It is an advantage of embodiments of the present invention that the groove geometry can be selected to result in stable guided particle motion.

It is an advantage of embodiments of the present invention that the groove geometry can be selected to result in little or no influence on the interface between co-flow liquids.

The above objective is accomplished by a method and apparatus according to the present invention.

In one aspect, the present invention relates to a microfluidic device for allowing particles to interact with a plurality of liquids, the microfluidic device comprising
a microfluidic channel having a bottom wall
a plurality of inlets for introducing the plurality of liquids in the microfluidic channel so as to create a plurality of parallel fluid flows in the microfluidic channel,
an inlet for Introducing dispensed particles in the microfluidic channel, and
a particle guiding groove for inducing lateral movement of the particles so that the particles are guided laterally by the particle guiding groove with respect to the average flow direction in the microchannel, so that the particles are guided through different liquids of the plurality of liquids.

Where in embodiments of the present invention reference is made to microfluidics, reference is made to devices and/or channels having at least one dimension within the range 1 μm to 1000 μm. Allowing particles to interact with a plurality of liquids may refer to applying multiple coatings to particles, having particles interacting with different liquids, or alike.

Where in embodiments reference is made to lateral movement, reference is made to a movement wherein there is at least a lateral component of movement with respect to the average flow direction, i.e. a velocity component in a direction perpendicular to the average flow direction.

The particle guiding groove is positioned in the bottom wall of the microfluidic channel.

The microfluidic device may be configured for having predetermined minimum flow rates of the plurality of liquids, and the groove may have a rectangular cross-section having a groove height, the predetermined minimum flow rates and the groove height being selected so as to induce a flow regime of the fluids such that, for each position along the particle guiding groove, the fluid in the particle guiding groove is the same as the fluid that is present above that position of the particle guiding groove.

The microfluidic device may be adapted for being connected to pumping units for pumping the different liquids or may comprise pumping units for pumping the different liquids at predetermined minimum flow rates. The microfluidic device may be adapted for operating at flow rates at or above 15 mm/s, for each of the different liquid flows.

The groove may have a width of at least 300 μm and the height of the microfluidic channel is at least 1 mm, and wherein the groove height is smaller than 150 μm.

The device may be intended for allowing particles having an average diameter d interact with the plurality of fluids, and the device may have one, more or all of a groove width being at least 5 times the average diameter d and a depth of at least ⅓ times the average diameter d or a depth of at least ½ times the average diameter d.

The microfluidic device may be configured for operating with particles having an average size d and with predetermined liquid flow rates, wherein the maximum angle made by the particle guiding groove with respect to the average flow direction is selected so as to avoid particles from leaving the particle guiding groove, taking into account the average particle size used, the liquid flow rates used and a height of the particle guiding groove.

Walls may be provided between the different fluids in order to reduce or avoid mixing of the parallel fluid flows.

The walls may be discontinuous at positions where they pass the guiding groove.

The walls may have recesses at positions where they pass the guiding groove.

The walls may be continuous near positions where they pass the guiding groove.

Aside the particle guiding groove an array of pillars or an additional guiding groove may be positioned.

In one aspect, the present invention also relates to a method for allowing particles to interact with a plurality of liquids, the method comprising
introducing the plurality of liquids in a microfluidic channel so as to create a plurality of parallel fluid flows in the microfluidic channel (102),
introducing dispensed particles in the microfluidic channel, and
inducing lateral movement of the particles so that the particles are guided laterally with respect to the average flow direction in the microchannel, so that the particles are guided through different liquids of the plurality of liquids.

Introducing the plurality of liquids may comprise introducing the plurality of liquids such that they flow in parallel fluid flows at flow rates at or above 15 mm/s, for each of the different liquid flows.

The method may be intended for allowing particles having an average diameter d to interact with the plurality of liquids, and the method may be inducing lateral movement of the particles using a groove having a groove width being at least 5 times the average diameter d and a groove depth of at least ⅓ times the average diameter d or a depth of at least ½ times the average diameter d.

Where reference is made to a groove width, the average width over the depth of the groove may be referred to. The groove may be a substantially rectangular groove, although embodiments are not limited thereto.

The method may furthermore comprise keeping the different fluids separated using walls.

Introducing dispensed particles in the microfluidic channel may comprise guiding particles into the microfluidic channel and into a particle guiding groove for subsequently inducing said lateral movement.

The present invention also relates to the use of a microfluidic device (100) for allowing particles to interact with a plurality of liquids. Allowing particles to interact with a plurality of liquids may for example coating particles with multiple layers, allowing particles to subsequently interact with different reactants, et.

Particular and preferred aspects of the invention are set out in the accompanying independent and dependent claims. Features from the dependent claims may be combined with features of the independent claims and with features of other dependent claims as appropriate and not merely as explicitly set out in the claims.

Although there has been constant improvement, change and evolution of devices in this field, the present concepts are believed to represent substantial new and novel improvements, including departures from prior practices, resulting in the provision of more efficient, stable and reliable devices of this nature.

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

### BRIEF DESCRIPTION OF THE DRAWINGS

FIG. 1 is a schematic representation of a microfluidic system comprising a guiding groove, according to embodiments of the present invention.

FIG. 2 illustrates an example of different flow regimes in the guiding groove as function of guiding groove depth and liquid velocity, as used in embodiments of the present invention to determine the appropriate size of the guiding groove and the liquid velocities to be used.

FIG. 3 illustrates mixed regimes as obtained for some guiding groove depth values and liquid velocities obtained in FIG. 2.

FIG. 4 illustrates how the particle guiding groove angle can be selected as function of particle guiding groove depth, liquid flow rates used and particle sizes used in embodiments of the present invention.

FIG. 5 illustrates how walls can be used between parallel liquid flows to avoid intermixing, as can be used in embodiments of the present invention.

FIG. 6 illustrates two measures that can be taken for improving the stability of the particles in the particle guiding groove in embodiments of the present invention.

FIG. 7, including FIGS. 7(a) to 7(d), illustrates a scheme of the chip: 7(a) top view, 7 (b) parts of the chip, 7(c) side view, 7(d) a zig-zag microfluidic chip according to an embodiment of the present invention.

FIG. 8, including FIGS. 8(a) and 8(b), illustrates a profilometer measurement of the groove depth before bonding the parts of the chip: 8(a) 3D view, 8(b) line profile, as used in an exemplary embodiment of the present invention

FIG. 9, including FIGS. 9(a) and 9(b), illustrates 9(a) Scheme of the experiment: (i) top view of the chip, (ii) cross section of the chip; 9(b) Three regimes observed for a groove at an angle of 15°, scale bar 1 mm:

(i) Regime 1—liquid in the groove is the same color as the liquid in the channel above the groove

(ii) Regime 2—liquid in the groove has different color than the liquid above it because liquid present at its the entrance invade the groove

(iii) Regime 3—color of the liquid in the groove is masked, as the dye is omnipresent in the channel

FIG. 10, including FIGS. 10(a) and 10(b), shows in 10(a) a particle following the groove of 10°, depth 45 μm, liquid velocity 12.5 mm/s; 10(b) a particle escaping the groove of 15°, depth 73 μm, liquid velocity 12.5 mm/s, as was obtained in an embodiment of the present invention. Scale bars are 1 mm.

FIG. 11, including FIGS. 11(a) to 11(d), shows the percentage of the particles of ø 89 μm following the groove of depth 11(a) 45±7 cm and 11(b) 72±7 μm. 11(c) Velocity of particles following a groove. Stability and velocity of particles depends on groove depth, angle, and flow rate of the carrier liquid. 11(d) Scheme of the chips, as could be derived in an embodiment of the present invention.

FIG. 12, including FIGS. 12(a) and 12(b), shows a Comsol simulation at a liquid flow rate of 25 mm/s 12(a) Cross section of the microfluidic channel showing the axial velocity field. 12(b) Local liquid velocity in the groove's direction for different groove angles and depth, in the center of groove (squares) and close to the groove's wall (circles) according to an embodiment of the present invention.

FIG. 13, including FIGS. 13(a) to 13(c), shows according to an embodiment of the present invention 13(a) The motion of a particle, driven by the fluid flow, in the groove. Long blue arrows show the fluid flow in the chip, and short blue arrows indicate the flow in the groove. Main forces and velocities (in the overdamped regime): the gravity force, F_{g}, is compensated by the reaction force from the bottom of the groove F_{rb}, the particle velocity in the groove, vᵣₚ, proportional to the fluid velocity in the groove resulting from the fluid velocity at the bottom of the chip, v_{fcb}, and the wall reaction force F_{rw}. 13(b) Imperfections at the bottom and lateral walls of the groove are modelled by a random force. 13(c) Examples of simulated particle trajectories: particles escape from the groove (blue and green circles) and following the groove (red circles).

FIG. 14, including FIGS. 14(a) and 14(b), shows according to an embodiment of the present invention 14(a) an optical microscopy picture of (a) the channel at different position of the chip; 14(b) the particles following the groove in the first zig-zag. Side liquids: EtOH with blue dye, middle liquid: EtOH. All three liquids are introduced at liquid velocity of 25 mm/s. Scale bar is 1 mm.

FIG. 15 shows according to an embodiment of the present invention a schematic representation of a PMMA-NH2 particle deposited with poly (acrylic acid) (PAA) and poly (ethylenimine) labeled with Rhodamine (PEI-Rh) bilayers by the layer-by-layer (LbL) technique. Steps 1-4 show the deposition of one bilayer of PAA/PEI-Rh (LbL-1-PMMA-NH2) on a PMMA-NH2 particle. Steps 5-8 show the deposition of second bilayer of PAA/PEI-Rh (LbL-2-PMMA-NH2) on a particle.

FIG. 16, including FIGS. 16(a) to 16(e), shows according to an embodiment of the present invention 16(a) Schematic representation of PMMA-NH2 particles deposited with poly (acrylic acid) (PAA) and poly (ethylenimine) labeled with Rhodamine (PEI-Rh) bilayers by the layer-by-layer (LbL) technique on chip. 16(b-c) Fluorescence photographs of PMMA-NH2 magnetic particles: 16(b) particles without coating (control), 16(c) particles with one bilayer (LbL-1-PMMA-NH2), coated in batch, 16(d) particles with two bilayers (LbL-2-PMMA-NH2), coated in batch, 16(e) with two bilayers (LbL-2-PMMA-NH2), coated on chip. Scale bars are 200 μm.

FIG. 17 shows according to an embodiment of the present invention a percentage of the particles of ø 89 μm following the groove. Reproducibility of the experiment in similar chips with groove of 44±7 μm at an angle of 10°.

FIG. 18 shows according to an embodiment of the present invention optical microscopy pictures of the channel at the different position of the chip. Side liquids: EtOH with blue dye, middle liquid: EtOH. All three liquids are introduced at liquid velocity of 25 mm/s. Scale bar is 1 mm. The radial diffusion of the blue dye over the length of the chip (15 cm) is negligible.

FIG. 19 shows according to an embodiment of the present invention an optical microscopy pictures of two particles traveling along the groove at different position of the chip. Full trajectory. Side liquids: EtOH with blue dye, middle liquid: EtOH. Liquid velocity is 25 mm/s. Scale bar is 1 mm.

FIG. 20, including FIGS. 20(a) to 20(d), shows a scheme of particles following the groove in a chip: 20(a) without wall, 20(b) with discontinuous walls, 20(c) with walls with openings, 20(d) with continuous walls. In 20(d) the particle must be smaller than the depth of the groove to get through below the walls. Colored arrows indicate direction of liquid flow along the axes of the chip. Aborted arrows indicate particle's direction.

FIG. 21, including FIGS. 21(a) to 21(c), 21(a) shows a scheme of zig-zag groove chips (top view): without walls (top) and with walls (bottom). Colored arrows indicate the direction of liquid flow. Walls separating the liquids are 0.5 mm thick. Channels are 1 mm high. Letters I₀ (at the beginning of the chip) and Iᵢ (in the end of the chip) indicates the position of the chip where an analysis of color intensity along the horizontal line (pink) took place. 21(b) Original picture of the chip with walls at the position indicated by I₀. 21(c) 8-bit transformation of picture 21 (b) with indication of the color analysis position (pink line). Scale bars are 1 mm.

FIG. 22, including FIGS. 22(a) to 22(d), shows an analysis of the difference in the color intensity at the beginning of the chip: I₀ and its end: Iᵢ. This difference is represented as a Separation, S:

$$S = 1 - \frac{\sum \vert \frac{{I}_{o , i}}{{I}_{o , ∞}} - \frac{{I}_{i}}{{I}_{i , ∞}} \vert}{\sum \vert \frac{{I}_{o , i}}{{I}_{o , ∞}} - 1 \vert}$$

where I_{0,∞} and I_{i,∞} is the average value of the intensity at the beginning and the end of the chip, respectively. Separation is presented in a graph as a function of 22(a) introduced middle liquid velocity V1, and the velocities of all introduced liquids are equal, V1=V2=V3. The points were measured at the same liquid flow rate but resulted in different velocity due to chip cross section 22(b) the liquid velocity ratio V1 to V2, and V2=V3. Lines are only for the eye-guide. 22(c-d) The pictures of the end of each chip at the conditions that scored the highest S value 22(c) on the graph 22(a) and 22(d) on the graph 22(b). Color of the picture frame is matching the color in the legend. Scale bars are 1 mm.

FIG. 23, including 23 (a) to 23(d), shows in 23(a) beginning of any chip: Pure ethanol is introduced in the middle channel at the flow rate Q1 and blue dyed ethanol at the side channels at the flow rates Q2 and Q3. 23(b) End of the chip with continuous walls into which three streams of ethanol are introduced at the flow rates Q1=Q2=Q3=80 mL/h (2.2 cm/s) 23(c-d) End of the chip without walls into which three stream of ethanol are introduced at the flow rates: 23(c) Q1=Q2=Q3=80 mL/h (1.7 cm/s) and 23(d) 240 mL/h (5.0 cm/s). Scale bar is 1 mm.

FIG. 24, including FIGS. 24(a) to 24(c), shows in 24(a) a scheme of groove-chip with discontinuous walls. Two possible situations at the gap between walls (see rounded arrows): 24(a) side liquid invade middle channel, 24(b) middle liquid invade side channel. The arrows indicate the direction of liquid flow. Scale bars are 1 mm.

FIG. 25, including FIGS. 25(a) to 25(c), shows a particle traveling on the groove through discontinuous walls 25(a) particle in the side channel 25(b) particle enters to the middle channel, 25(c) particle enters the other side channel. The liquid flow direction is from left to right. The walls are highlighted by intermittent, white lines. Scale bars is 1 mm·μ

FIG. 26, including FIGS. 26(a) to 26(c), shows a chip with turn and walls with openings: 26(a) scheme of the chip with the zigzag groove suitable for coating particles with 8 layers, the groove is marked in red 26(b) close look at the area of the scheme indicated by yellow rectangle in picture 26(a); 26(c) photos of the particles traveling in the groove inside the chip at the positions indicated by yellow rectangle in picture 26(b); the walls are highlighted by intermittent, white lines. Middle, transparent liquid is marked in white on the scheme, and side, dyed liquids are marked in navy blue. Scale bars are 1 mm.

FIG. 27 Particle's stability on the groove as a function of groove angle and liquid velocity for particles diameter 41, 67 and 89 μm in 53 μm (left), 75 (middle), 130 (right) deep grooves. Coloured areas indicate conditions at which at least 93% of particles of particular size follow the groove. Grey area indicates the conditions where fraction of all three size of particles do not follow the groove.

FIG. 28 Stream separation quality at the absence of walls. Images recorded at the beginning (first column) and end (rest) of the chip without walls. For all columns the liquid flow rate Q is indicated at the top of the column in mL/h and corresponding to it liquid velocity is indicated in brackets in mm/s. Each raw represents different set of experiment. Top raw: all three liquids were introduced in the chip at the equal flow rate Q1=Q2=Q3=Q. Middle raw: side liquids were introduced at the flow rate Q2=Q3-80 mL/h and velocity 17 mm/s. Middle liquid was introduced at liquid flow rate Q. Bottom raw: side liquids were introduced at the flow rate Q2=Q3=120 mL/h and velocity 25 mm/s. Middle liquid was introduced at liquid flow rate Q. White, intermittent lines indicate the area that is excluded for calculations of difference in color intensity at the beginning and the end of the chip because for each point enclosed in that area (in the pictures of chip's end) the beginning reference is a wall.

FIG. 29. Stream separation quality at the presence of discontinuous walls. Images recorded at the beginning (first column) and end (rest) of the chip with discontinuous walls. For all columns the liquid flow rate Q is indicated at the top of the column in mL/h and corresponding to it liquid velocity is indicated in brackets in mm/s. Each raw represents different set of experiment. Top raw: all three liquids were introduced in the chip at the equal flow rate Q1=Q2=Q3=Q. Middle raw: side liquids were introduced at the flow rate Q2-Q3-80 mL/h and velocity 22 mm/s. Middle liquid was introduced at liquid flow rate Q. Bottom raw: side liquids were introduced at the flow rate Q2=Q3=120 mL/h and velocity 33 mm/s. Middle liquid was introduced at liquid flow rate Q.

FIG. 30 Stream separation quality at the presence of walls with openings. Images recorded at the beginning (first column) and end (rest) of the chip with walls with openings. For all columns the liquid flow rate Q is indicated at the top of the column in mL/h and corresponding to it liquid velocity is indicated in brackets in mm/s. Each raw represents different set of experiment. Top raw: all three liquids were introduced in the chip at the equal flow rate Q1=Q2=Q3=Q. Middle raw: side liquids were introduced at the flow rate Q2=Q3=80 mL/h and velocity 22 mm/s. Middle liquid was introduced at liquid flow rate Q. Bottom raw: side liquids were introduced at the flow rate Q2=Q3=120 mL/h and velocity 33 mm/s. Middle liquid was introduced at liquid flow rate Q.

FIG. 31 Stream separation quality at the presence of continuous walls. Images recorded at the beginning (first column) and end (rest) of the chip with walls. For all columns the liquid flow rate Q is indicated at the top of the column in mL/h and corresponding to it liquid velocity is indicated in brackets in mm/s. Each raw represents different set of experiment. Top raw: all three liquids were introduced in the chip at the equal flow rate Q1=Q2=Q3=Q. Middle raw: side liquids were introduced at the flow rate Q2=Q3=80 mL/h and velocity 22 mm/s. Middle liquid was introduced at liquid flow rate Q. Bottom raw: side liquids were introduced at the flow rate Q2=Q3=120 mL/h and velocity 33 mm/s. Middle liquid was introduced at liquid flow rate Q.

FIG. 32 Stream separation quality at the presence of walls with openings. Images recorded at the beginning (first column) and end (rest) of the chip with turn and with walls with openings. For all columns the liquid flow rate Q is indicated at the top of the column in mL/h and corresponding to it liquid velocity is indicated in brackets in mm/s. Each raw represents different set of experiment. Top raw: all three liquids were introduced in the chip at the equal flow rate Q1=Q2=Q3=Q. Middle raw: side liquids were introduced at the flow rate Q2=Q3-80 mL/h and velocity 22 mm/s. Middle liquid was introduced at liquid flow rate Q. Bottom raw: side liquids were introduced at the flow rate Q2-Q3=120 mL/h and velocity 33 mm/s. Middle liquid was introduced at liquid flow rate Q.

FIG. 33 illustrates different flow regimes for different guidance groove parameters, according to some embodiments of the present invention.

In the different figures, the same reference signs refer to the same or analogous elements.

### DESCRIPTION OF ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. The term “comprising” therefore covers the situation where only the stated features are present and the situation where these features and one or more other features are present. The word “comprising” according to the invention therefore also includes as one embodiment that no further components are present. Thus, the scope of the expression “a device comprising means A and B” should not be interpreted as being limited to devices consisting only of components A and B. It means that with respect to the present invention, the only relevant components of the device are A and B.

Similarly, it is to be noticed that the term “coupled”, also used in the claims, should not be interpreted as being restricted to direct connections only. The terms “coupled” and “connected”, along with their derivatives, may be used. It should be understood that these terms are not intended as synonyms for each other. Thus, the scope of the expression “a device A coupled to a device B” should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly, it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some, but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

The invention will now be described by a detailed description of several embodiments of the invention. It is clear that other embodiments of the invention can be configured according to the knowledge of persons skilled in the art without departing from the technical teaching of the invention, the invention being limited only by the terms of the appended claims.

The present invention relates to a microfluidic device and a method for allowing particles to interact with a plurality of liquids is provided. The microfluidic device comprises a microfluidic channel having a bottom wall, a plurality of inlets for introducing the plurality of liquids in the microfluidic channel so as to create a plurality of parallel fluid flows in the microfluidic channel and an inlet for Introducing dispensed particles in the microfluidic channel. The microfluidic device also comprises a particle guiding groove for inducing lateral movement of the particles in the microfluidic channel so that the particles are guided laterally by the particle guiding groove with respect to the average flow direction in the microchannel, so that the particles are guided through different liquids of the plurality of liquids.

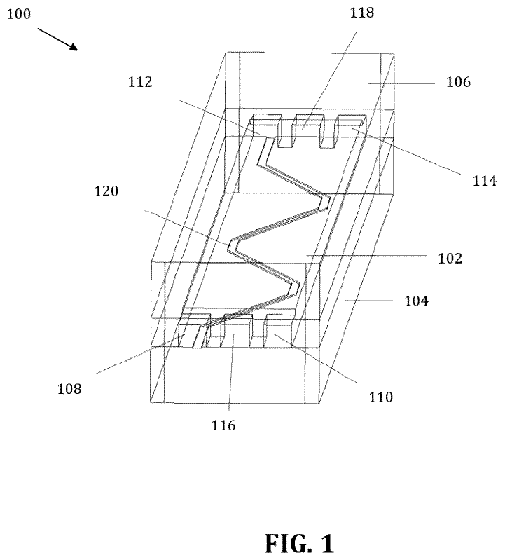

By way of illustration, embodiments of the present invention not being limited thereto, an exemplary microfluidic system 100 in FIG. 1. The microfluidic system 100 comprises a microfluidic channel 102 having a bottom wall 104 and a top wall 106, also referred to as lid. In the example given, a system for allowing particles to interact with two different liquids is shown. It nevertheless is to be noted that the systems according to embodiments of the present invention are not limited thereto, but that the system may be suitable for interaction with 2, 3, 4, 5, 6, 7, 8 or more liquids. The latter thus allows for interaction with 2, 3, 4, 5, 6, 7, 8 or more liquids, whereby also multiple interactions are possible if the particle is guided multiple times in the liquid stream. Typically, the liquid streams will be parallel to each other. The microfluidic system 100 typically may thus have two or more liquid inlets for separately guiding these liquids into the microfluidic channel and typically may have two or more liquid outlets for separately guiding these liquids out of the microfluidic channel. In the example shown in FIG. 1, a liquid inlet 108 for the first liquid, a liquid inlet for the second liquid 110, a liquid outlet for the first liquid 112 and a liquid outlet for the second fluid 114 is shown. The microfluidic system 100 furthermore comprises an washing-solution inlet 116 for the particles, which typically are introduced using a washing-solution wherein the particles are dispersed. Furthermore, the microfluidic system 100 typically also comprises a washing-solution outlet 118 for guiding the washing solution out of the microfluidic channel 102. According to embodiments of the present invention, the microfluidic system 100 also comprises a guiding groove 120, typically positioned in the bottom wall 104. The guiding groove 120 may for example be a groove, for example a groove having a rectangular cross-section. The guiding groove 120 is configured for guiding the particles so that these are guided through different liquids. The particles thus, once they have entered the microfluidic channel and once they have reached the guiding groove, are confined in the guiding groove and are guided through the different liquids. The latter may allow contacting the particles with the different liquids for example to coat the particles with the different liquids, for allowing interaction between the particles and the different liquids for inducing chemical or physical reactions, or for other purposes. The groove may also be referred to as a laterally oriented groove, since it allows to guide the particles in the lateral direction with respect to the average flow direction. The average flow direction typically may be an axial direction of the microfluidic channel.

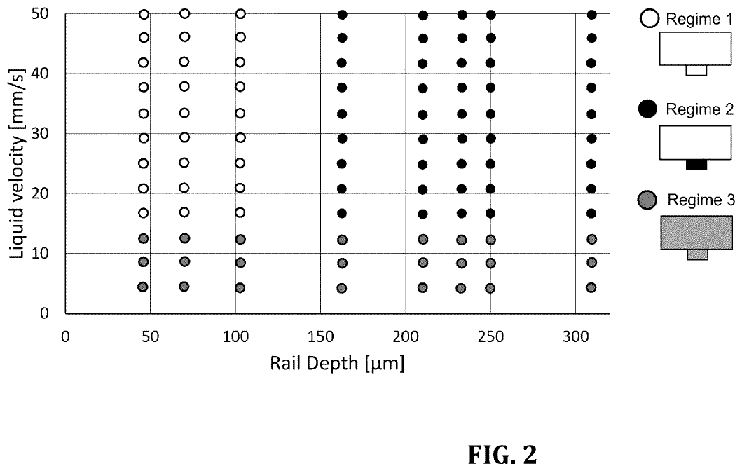

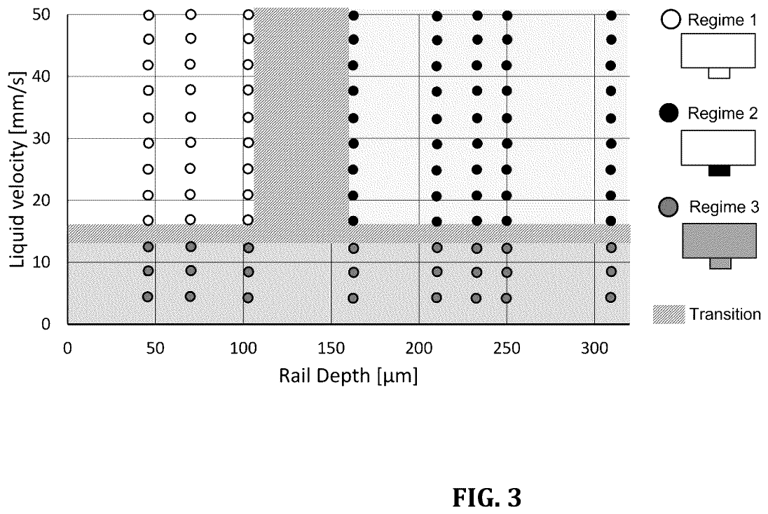

The guiding groove size is selected so that the particles typically are confined in the groove, e.g. by sedimentation or buoyancy. Under the influence of gravity, the groove induces a lateral movement of the particles, without substantially disturbing the liquid. The depth of the guiding groove typically is selected so that, in combination with the liquid velocity chosen, the liquid does not flow in the groove and contaminates adjacent co-flows. By way of illustration, FIG. 2, shows the different regimes for a range of liquid velocities and for a range of depths of the guiding groove for a guiding groove being 300 μm wide and a channel heigh of 1 mm. Regime 1 is a regime wherein the liquid at a given position in the guiding groove corresponds with the liquid that is positioned above the guiding groove in the system. Regime 2 is a regime wherein the liquid in the guiding groove does not correspond for all positions of the guiding groove with the liquid that is positioned above that position in the guiding groove. In this regime, one of the liquids invades the guiding groove also at positions where this liquid is not above the guiding groove. In some cases, one liquid fills up the full guiding groove. In regime 3, the liquid velocities are such that no clear borders are visible anymore between co-flowing liquids. A corresponding drawing FIG. 2 can be made for other guiding groove widths and channel heights by routine experiments. An exemplary way of setting up such a regime drawing is also described in more detail in the exemplary experiments described below. From FIG. 2 it can be derived that, for a guiding groove width of 300 μm and a channel height of 1 mm, the liquid velocities used should be higher than 15 mm/s and the depth of the guiding groove should be less than 150 μm. Further by way of illustration, FIG. 3 illustrates the transitional areas between the different regimes, where regime 1 and regime 2 cannot be distinguished, these areas referred to as mixed regimes.

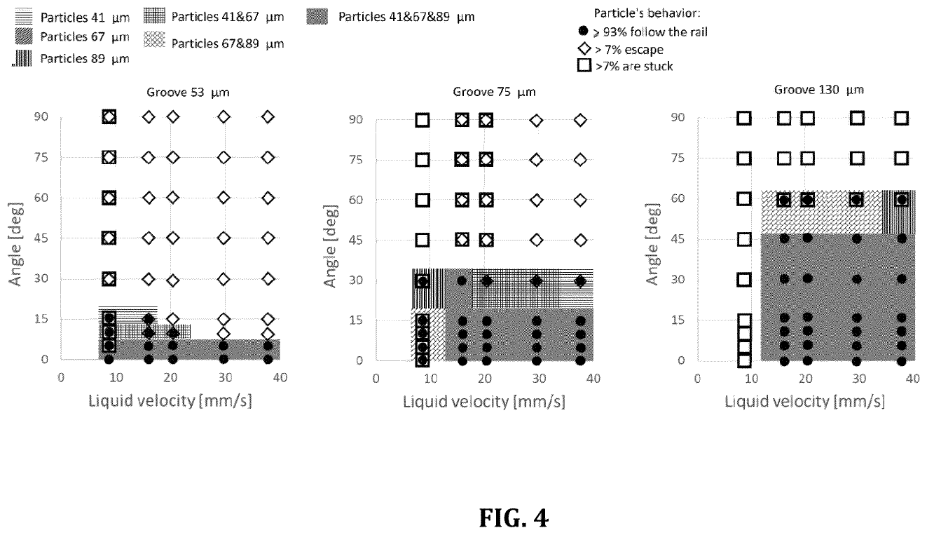

Another consideration to be made is that the angle of the particle guiding groove 120 with respect to the average flow direction in the microfluidic channel should be smaller than a given value. The stability of the particle depends on the groove depth, groove angle, liquid flow rate (which also defines the particle velocity) and particle diameter. By way of illustration, embodiments of the present invention not being limited thereto, an example for particles with a diameter of 41 μm, 67 μm and 89 μm in a particle guiding groove having a height of 53 μm (left), 75 μm (middle) and 130 μm (right) is shown in FIG. 4. The patterned areas indicate conditions at which all particles of particular size follow the groove whereas the non-patterned areas indicate the conditions where fraction of all three size of particles do not follow the groove. Such analysis can be performed for particle diameters used with a given microfluidic device, as well as for liquid flow rates one wishes to use, for example as function of the flow regime one wishes to obtain in the microfluidic device.

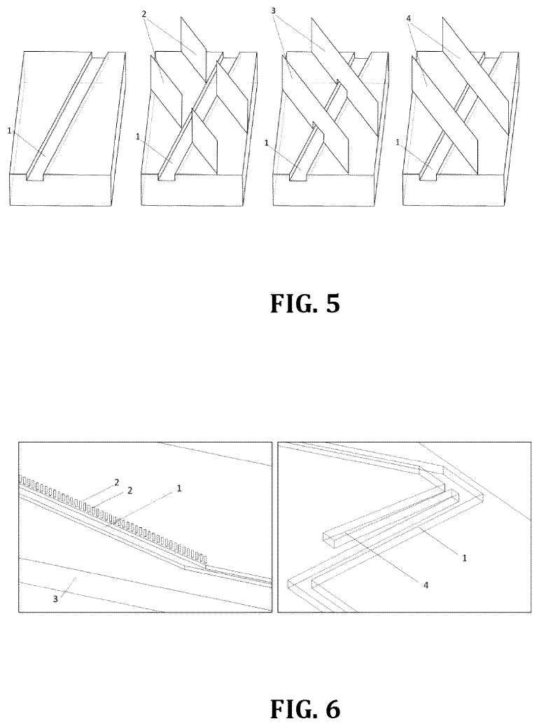

For long cycle numbers and/or residence times of the particles in the reactor, the liquids will diffuse in one another and will mix, leading to loss of appropriate coating conditions. To overcome this, in some embodiments, walls can be provided below which particles can flow, but through which no diffusion on liquid can take place, except near openings. This allows for much more freedom in residence time. Thus walls are provided between the different fluids in order to reduce or avoid mixing of the parallel fluid flows. The latter is shown in FIG. 5. The walls may be discontinuous at positions where they pass the guiding groove, wherein the walls have recesses at positions where they pass the guiding groove or wherein the walls are continuous near positions where they pass the guiding groove.

Further in some embodiments, additional measures may be taken to reduce fouling or deposition of materials, resulting for example in particles leaving the particle guiding groove more rapidly. Such additional measures may be for example the introduction of an array of pillars aside the particle guiding groove or introducing a second groove aside the particle guiding groove. The latter may assist in enhancing stability for particles to be restricted to the particle guiding groove. Examples thereof are shown in FIG. 6.

Further features and advantages will become apparent from exemplary embodiments and examples discussed below—embodiments not being limited thereby.

By way of illustration, embodiments of the present invention not being limited thereto, features and advantages of exemplary embodiments are illustrated in the examples given below. The chips and liquids used in these examples are described first.

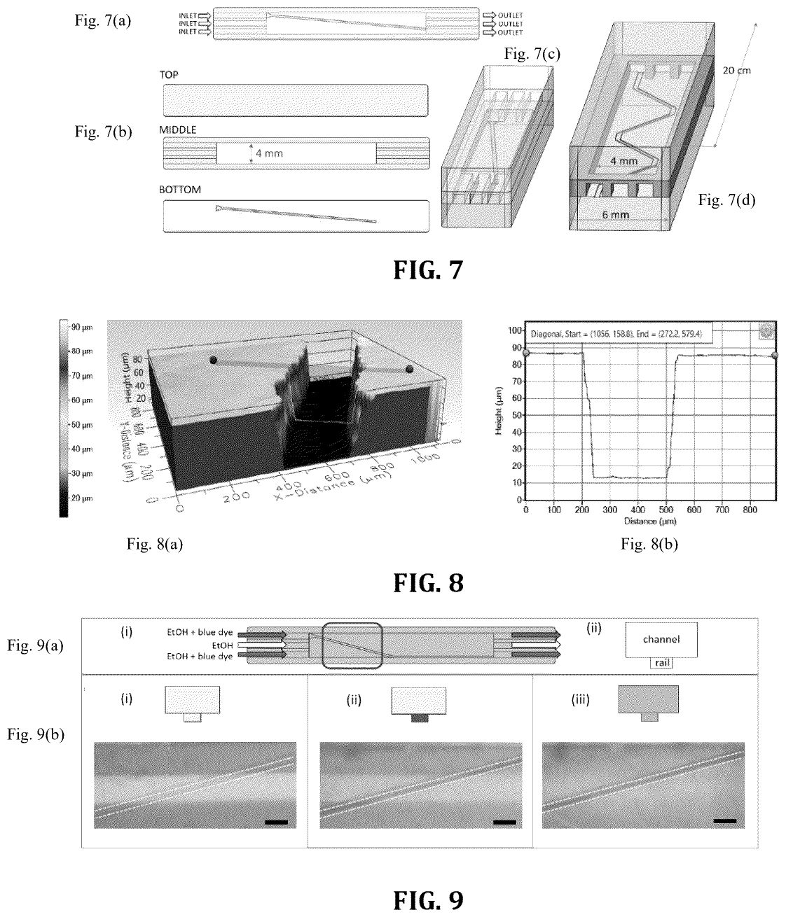

The chip used was fabricated in-house by milling polymethyl-methacrylate (PMMA) as substrate. PMMA was the material of choice because of its transparency and ease of machining. The chip outline is presented in FIG. 7. The chip was composed of three different layers that were subsequently assembled and bonded. The chip had three inlets and three outlets and the dimensions of the top layer were 6 mm×50 mm (2 mm thick). The middle layer was 1 mm thick and had a 4 mm wide and 30 mm long channel. The bottom part of the chip was 2 mm thick and had a groove milled on its surface. At the beginning of the groove there was a groove area in the shape of a triangle to facilitate entrapment of the particles introduced with the liquid during the experiment. The width of the groove was 300 μm and the depth of the groove was 45 to 310 μm, depending on the chip design. The depth of the groove was determined by a profilometer (Filmetrics Profilm 3D). Measurements were taken at five different positions for each groove, as shown in FIG. 8, before bonding the chip. The same method was applied to measure the roughness Ra of the bottom surface of the chip and the groove. Typical values obtained perpendicular and vertical to the groove were 100 nm. After testing different angles of grooves: 0°, 5°, 10°, 15°; a zig-zag chip was designed and fabricated, as shown in FIG. 7(d). The zig-zag chip was designed for on-chip LbL coating of particles and was built, similar to previous chips, from three layers, but it was longer (20 cm); and its groove was built of 0° and 5° grooves connected together in a shape of a zig-zag. The parts of the chip were assembled and bonded with the use of ethyl acetate that was introduced in the discrete amount between the layers of the chip. Glass capillaries (ID 450 μm, OD 670 μm, Polymicro, Achrom) were glued to the chip inlets and outlets in order to introduce the liquids with the use of syringe pumps or pressurized pumps (Fluigent). In case of suspension of particles, Vortex was used to vibrate Falcon tube containing particles suspension in order to prevent sedimentation of particles to the bottom of the Falcon tube.

Ethanol was chosen as carrier liquid to study the behavior of the liquid flow in the chip because of multiple reasons, with the most important one that it is an excellent solvent for many chemicals. Moreover, it wets PMMA which ensures easy removal of gas bubbles and prevents particles to sticks to the surface. Ethanol is compatible with PMMA for moderate use of time (very long exposure of PMMA to ethanol causes cracks to material), which allowed us to test different geometry of prototype chip.

Ethanol was introduced to the chip through the three inlets. The middle stream was pure while the adjacent streams were colored with blue dye to visualize the flow, see FIG. 9(a). The flow rate of all three liquids was controlled with a syringe pump. The liquids were always introduced at the same flow rate, ranging from 20 to 240 mL/h with corresponding linear liquid velocities of 4.2 to 50 mm s⁻¹. Note that these values refer to average liquid velocities in the chip. The liquid velocity was maximal at the central part of the flow and decreased to zero at the boundary. Therefore, at the level of particles moving near the bottom of the chip the fluid velocity was substantially smaller than the average value. The actual fluid velocities at the level of particles were estimated as described further below.

Magnetic polystyrene particles (PS-MAG-AR110, 89 μm, SD=1.2 μm, Iron oxide=10%, Microparticles GmbH) and magnetic amino functionalized poly (methyl methacrylate) particles (PMMA-MAG-NH2, 98.5 μm, Microparticles GmbH) were used.

Polyethyleneimine, (PEI, branched, average 25 kDa by LS average Mn 10 kDa by GPC) and Poly (acrylic acid) (PAA) (35 wt; % solution in water, typical MW 100 kDa) were purchased from Aldrich. Rhodamine isothiocyanate was purchased from Cayman Chemical Company. PEI was dissolved in dimethyl sulfoxide, DMSO (Sigma-Aldrich) together with rhodamine B isothiocyanate (RITC, mixed isomers, Cayman Chemical Company). Mixture was stirred for 5 h. After that ethanol was added to dilute the PEI to 1%. Mixture was dialyzed against ethanol (dialysis bag with cut off 12-15 kDa) for one week in order to remove DMSO and not reacted RITC. Concentration of dialyzed PEI-Rhodamine (PEI-Rh) labeled solution was calculated as 0.87% and used as a stock solution.

When performing the experiments, three types of behavior of liquid flow were observed, further referred to as regimes 1, 2 and 3, as also illustrated by FIG. 9(b).

### Regime 1

Three clear stripes of blue-transparent-blue of co-flowing liquids were observed. The liquid in the entire area of the middle stream was transparent. This means that (transparent) ethanol was in the groove and in the channel above the groove. The groove was filled by the different liquids depending on the position of the groove in the chip. It was filled by the liquid that flows above it.

### Regime 2

Although the co-flow of the three liquids can be distinguished, the blue colored ethanol was present in the entire length of the groove. This was visible in the chip where transparent ethanol flows in the middle of the channel while below blue colored ethanol flowed inside the groove. The beginning of the groove was at the entrance of the chip where blue colored ethanol was introduced. This liquid invaded the groove and filled it up through all its length. The same behavior was observed for the grooves with and without triangle shape at the beginning of the groove.

### Regime 3

Clear borders between co-flowing liquids were no longer observed. The blue dye covers the area of the middle stream.

The occurrence of the three regimes of liquid transport in the groove as a function of groove depth and liquid velocity is summarized in FIG. 2 and FIG. 3 shown earlier. Regime 1 was observed for velocities of the liquids >15 mm s⁻¹ with a groove depth <100 μm. Regime 2 was observed for velocities of the liquids >15 mm s⁻¹ and grooves of the depth >160 μm. Regime 3 was observed for low velocities of the liquids <15 mm s⁻¹ and all range of grooves tested.

The area between Regime 1 and Regime 2 (velocities of the liquids >15 mm s⁻¹, grooves of the depth between 100 and 160 μm) is classified as mixed regime of 1 and 2 as it does not clearly fall into Regime 1 or 2.

With the aim to provide conditions for repetitive chemical treatments on particles, only the conditions leading to Regime 1 were considered appropriate in this example because each particle traveling in the groove must be in contact with the liquid of the same nature as the liquid above the groove. For LbL coating procedures e.g., particles must travel through three different liquids to undergo bilayer coating, i.e. liquid with first coating agent, rinsing liquid, liquid with second coating agent

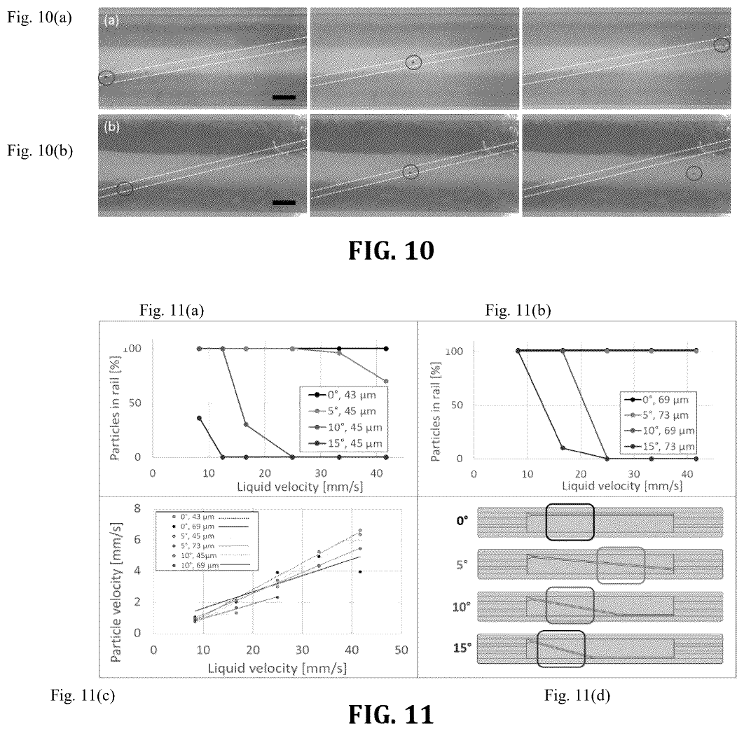

In order to test how do particles follow the groove, particles of 89 μm diameter were introduced in the chip as a suspension in blue colored ethanol. The suspension was introduced at the inlet which is connected to the initial part of the groove. A triangular shape was foreseen at the start of the groove to facilitate the introduction of particles into the groove. The velocity of the particles introduced to the chip quickly decreases as soon as the particles touch the bottom of the chip. It is crucial that the particles touch the surface of the bottom of the chip to be able to fall into the groove. The area of the chip (4 mm wide×10 mm long) where the groove crossed the liquid flow was monitored to evaluate whether the particles follow the groove, therewith crossing three streams of liquid, see FIG. 10. The particle must follow the groove without touching other particles. If they do, this can lead to bumping and subsequent escape of one or both particles. Only single particle events were considered in the present study.

The behavior of the particles on the grooves with the angles to the channel axis was studied: 0°, 5°, 10° and 15°. The scheme of the chip is presented in FIG. 11(d). Studied depths of the groove were 45±7 and 70±7 μm. The range of liquid flow rate studied was 4.2-42 mm s⁻¹. It was observed that at liquid velocity below 6.5 mm s⁻¹ particles do not travel undisturbed all the way through the chip and often stop (stick) to the surface of the chip.

Particles traveling in the groove were recorded and measured their velocity using GDPTlab v1.2 a Matlab GUI. First, the colors of black and white pictures were inverted using Matlab code because GDPTlab works only with dark field images (dark background and bright particle images). Then, we analyzed positions of each particle with GDPTlab and measured its displacement within a given time FIG. 11c. Each point represents measurement on minimum 10 particles. The error on the particle's velocity is ±15%. The liquid average velocity was calculated by measuring the time of collecting the liquid at the outlet of the chip in a measuring cylinder. The error on liquid velocity was ±5%. As can be noticed, the particle velocity in the groove depended only to a minor extent on the angle of the groove but mostly on the liquid velocity. The velocity of the particle following the groove was much lower than that of the particle outside the groove. Overall, the particles displacement in the groove (in the groove direction) was about ten times slower than the average liquid velocity (in axial direction) in the channel.

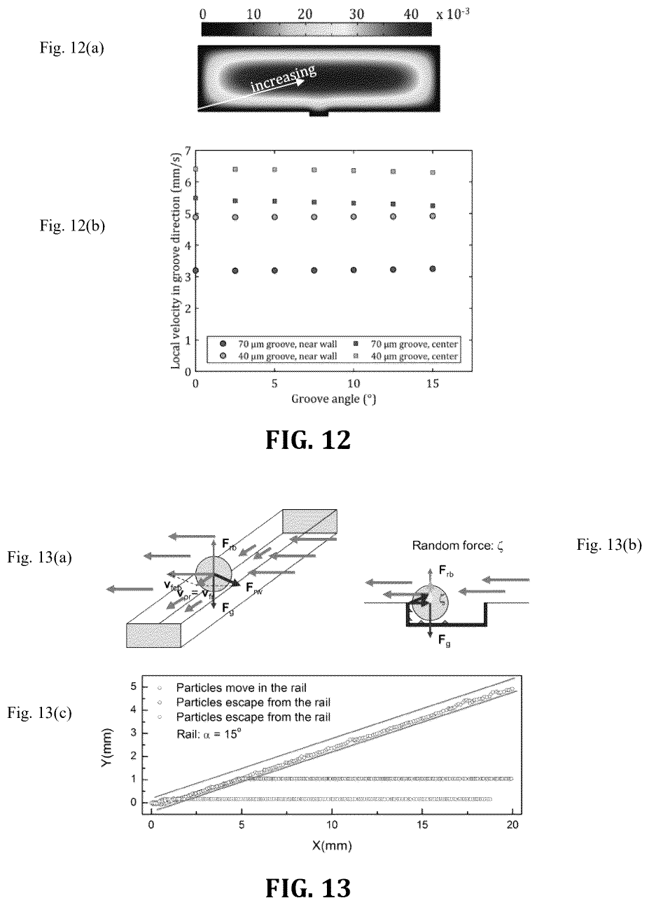

The observed lower linear velocity can be attributed to a lower local velocity than the average velocity in the entire channel on the one hand, and the occurrence of (rotational and frictional) forces acting on the particle. To assess the magnitude of the velocity effect, COMSOL simulations were performed at different groove angles from 0° and 15°, assuming a fixed average axial flow rate of 25 mm/s Re=18.4). The magnitude of the axial velocity field is shown in FIG. 12(a). As can be noticed, the presence of the shallow groove only has a small influence on the axial velocity field in the microfluidic channel. To compare the observed velocity of the particles in the groove, the local liquid velocity in the groove direction at a height of the particle radius (44.5 μm) was measured. From FIG. 12(b) it can be seen that slightly higher velocities are observed for a shallower groove. Moreover, the velocity decreases slightly with increasing angle size. At 25 mm/s, the liquid velocity near the particle center was (5.4±0.1 mm/s for 70 μm deep groove and 6.3±0.1 mm/s for 40 μm deep groove) much smaller than the average flow velocity (25 mm/s), but still considerable larger than the observed particle velocity (3.0±1.0 mm/s). The local velocity might vary slightly depending on the position of the groove. It was assumed that the particle remains near the center of the groove while in reality it is pushed towards the groove's wall, where the velocity is slightly lower (i.e. 3.2±01 mm/s for 70 μm deep groove and 4.9±0.1 mm/s for 40 μm deep groove). The remaining velocity difference can be attributed to frictional and rotational forces (see section below for more details).

FIG. 11(a) shows the fraction of the particles that follow the groove of 45±7 μm depth. It is observed that as the velocity of the liquid increases, more particles escape the groove. It is notable that the angle of the groove is also a very important factor. All particles travel within the trajectory of the groove of 0° and 5° until a liquid velocity of 25 mm s⁻¹. As a comparison, for the same liquid velocity of 25 mm s⁻¹, none of the particles are in the groove of angle 10° and 15°. The higher the angle of the groove, the higher the fraction of the particles that escapes for a given liquid velocity. Another important factor determining particle stability is the depth of the groove. The fraction of particles traveling in the guidance of the groove is much higher for the same liquid velocity and groove angle condition when the groove is deeper as shown in FIG. 11(b).

The definition quality of the groove obviously also plays a critical role. The CNC machined grooves have small imperfections and a local roughness that is in the micron range. With the profilometer shown in FIG. 8 five areas were measured of the same groove and it gives a difference in depth of ±7 μm. The experiment was performed in similar chips of the groove of 10° and depth 43±7 and 45±7 μm. Although the lines representing the fraction of the particles in the groove as a function of liquid velocity for similar chips were not identical it is remarkable that they all have the same position of the threshold at which the particles start to be unstable in the groove and escape. Different fraction of the particles that stay in the groove can represent the reproducibility of milling the groove.

Imperfections of the surface of the lateral walls and the bottom of the groove trigger the escape events. Indeed, for particles with the radius smaller than the depth of the groove they should always remain inside the groove, provided the surface of the groove is perfect. Scattering of the moving particles on imperfections result in an additional force that kicks the moving particles out of the groove. Thus, the process of escape can be modelled by adding a random force in the equations of motion, similarly to the thermal force in the case of Brownian particles.

For a particle driven by the flow inside the groove, as shown in FIG. 13, pair forces are balanced: the gravity is balanced by the surface reaction force, the acceleration is balanced by the Stokes drag and the friction force with the surfaces. As a result, the particle moves with a constant velocity proportional to the fluid velocity at the level of the particle, and its motion is affected by the random force due to the imperfections. This motion can be modelled by simple overdamped equations,

$$\dot{x} = {v}_{0} cos θ + {ξ}_{0 , x} ( t ) + \sum {f}_{x} \qquad Eq . ( 1 )$$

$$\dot{y} = {v}_{0} sin θ + {ξ}_{0 , y} ( t ) + \sum {f}_{y} ,$$

where v₀ is the velocity of the particle driven by the fluid flow (in the absence of other forces), θ is the direction of the flow with respect to the chip, ξ₀(t)=(ξ_{0,x}(t), ξ_{0,y}(t)) is a two-dimensional non-correlated thermal-like Gaussian noise (due to the imperfections), and the latter term, E f, is the sum of other forces that, as mentioned above, are considered to be balanced. Note that Eq. (1) is similar to the Langevin equations describing the motion of self-propelled particles, where the driving velocity v₀ corresponds to self-driven velocity of self-propelled particles. The simulation results for the angle θ=15°, with the corresponding boundary conditions modelling the groove, are presented in FIG. 13, where three typical trajectories are shown. One corresponds to the case when the escape event occurs at the very beginning of the motion of a particle in the groove. The other one shows an escape around the middle of the groove. After the escape, the particles move on the bottom of the chip following the direction of the fluid. Finally, the case is shown in the figure when a particle does not escape and remains in the groove. The presented simulated trajectories correspond to those observed in the experiment.

### Tests on Zig Zag

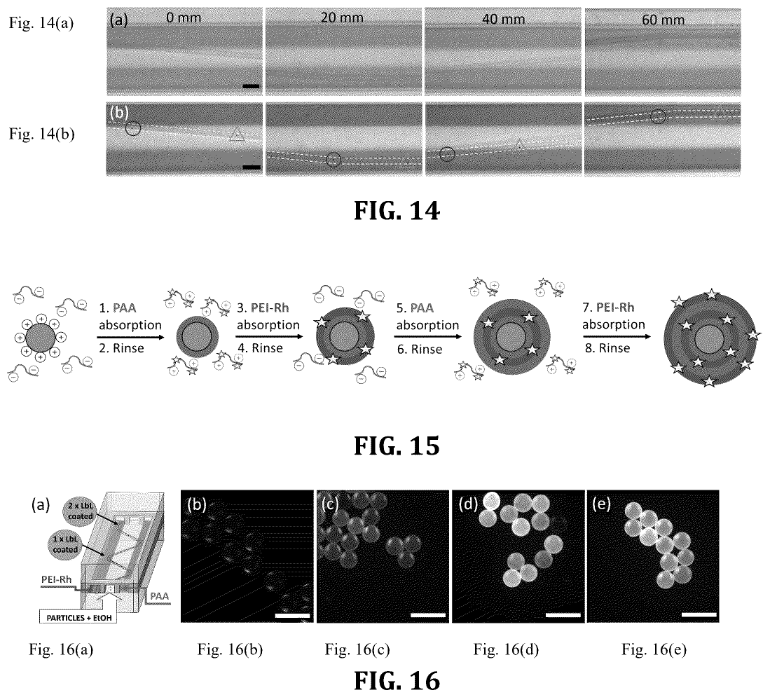

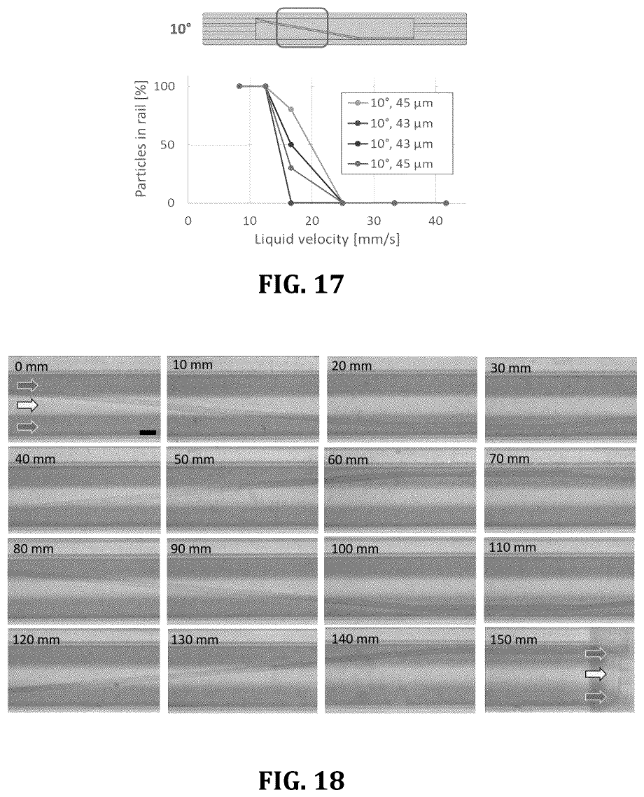

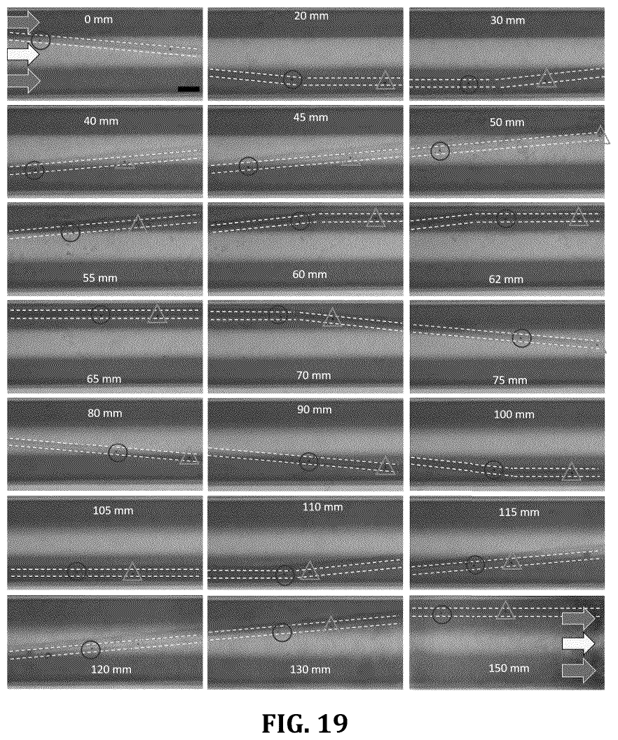

After defining the optimum geometry of the groove and range of the liquid velocity, the conditions as described above were applied on a zig-zag chip, see FIG. 7(d). The zig-zag chip had the groove of 70±7 μm built of alternating groove with the angle: −5°, 0°, 5°, 0° (first zig-zag) and again −5°, 0°, 5°, 0° (second zig-zag). First the three streams of ethanol were introduced at a velocity of 25 mm s⁻¹. Side streams were colored with Patent blue (blue) for visualization of liquid flow. The particles were introduced in the middle (ethanol) stream. Side liquid streams were blue colored ethanol. Through the entire length of the zig-zag chip, the liquid behavior followed Regime 1. This can be seen on FIG. 14(a) and FIG. 17. Moreover, the diffusion of dye from side streams to the middle stream was negligible for the entire chip length.

Particles were introduced to the chip into the middle stream. This gives them the possibility to get trapped in the groove while they are still present in rinsing solution. This guarantees that all particles spend the same time in the side stream. Particles followed the groove that is presented on FIG. 14(a), first zig-zag, and FIG. 18 (first and second zig-zag). The distance between particles changed depending on the position in the chip. Closer to the side (groove) 0° the particles moved slightly slower and got closer to each other. Therefore, it was preferred that particles were introduced to the chip with a distance of >5 mm between them.

A solution of poly (acrylic acid) PAA (0.033% w/w) in ethanol and a solution of poly (ethylenimine) labeled with rhodamine PEI-Rh (0.033% w/w) in ethanol were used. Each step of coating was alternated by rinsing the particles with ethanol FIG. 15. The deposition of the PAA/PEI-Rh bilayer was verified by fluorescence microscopy.

### Batch Experiment

For deposition of the first layer, 0.5 mL of a PAA solution was added to a glass vial containing positively charged PMMA-MAG-NH2. Adsorption was allowed to proceed for 10 min followed with a gentle shaking. After that, particles were kept at the bottom of the vial with the help of magnet, the solution was removed, and the particles were washed twice with adding ethanol. A 0.5 mL of PEI-Rh solution was then added to the PAA coated particles and allowed to interact for 10 min, followed by the removal of the solution and washing with ethanol. The process was repeated leading to the deposition of a second PAA/PEI-Rh bilayer.

### On Chip Experiment

Next, coating of the particles was performed with the zig-zag chip, which has a groove of 75±7 μm. The side streams are composed of PAA ethanol solution (polyanion solution) and PEI-Rh ethanol solution (polycation solution). Ethanol is introduced in the middle stream as a rinsing solution. Positively charged PMMA-MAG-NH2 particles (98.5 μm diameter) were introduced in the middle stream and are sequentially carried by the PAA solution, ethanol and PEI-Rh stream in order to undergo deposition of the first bilayer (first zig-zag). After following the trajectory of the second zig-zag the second bilayer was deposited, as shown in FIG. 16(a). Particles were collected at the outlet of the chip into a glass beaker containing ethanol. After the particles had sedimented, the liquid was removed by washing the particles twice with ethanol. Fluorescent microscopy pictures confirmed presence of two bilayers, as can be seen in FIG. 16(b). The intensity of the fluorescence was comparable with those of particles with two bilayers coated in batch.

In FIG. 16(b) to (e), fluorescent microscopy pictures are presented of PMMA-MAG-NH2 particles with (b) zero, (c) one, and (d) two bilayers. Particles with no coating show no fluorescence. Particles with two bilayers shows higher intensity than particles with one bilayer.

Whole process of coating the particles with 4 sublayers required 7 sequential steps: 1—PAA, 2—washing, 3—PEI-Rh, 4—washing, 5—PAA, 6—washing, 7—PEI-Rh and took about a minute. Particles were exposed to coating solution for dozen of seconds that was sufficient too undergo the deposition of sublayer. LbL coating usually is quick but in case the longer time of reaction is needed the flow rates of liquids introduced can be decreased. This has to be carefully adapted in such a way that the system is still in Regime 1 and not Regime 3. In order to stay in Regime 1 it is possible to change the geometry of the chip-longer or to widen the channel, or to eventually introduce walls between the streams. The system can be adapted to particles with different diameters, e.g. by adapting the depth of the groove.

The system can be used in multiple chemical and biological assays (for example immunoassays) that require numerous liquid reagents and washes that are introduced sequentially.

The above example shows that Layer-by-Layer coating of particles can be successfully performed on chip using a groove guided method. An LbL coating procedure in one continuous process was described and it was demonstrated in a specific example that a chip can replace 7 consecutives steps in batch. Using grooves provides control over trajectory of the particles and ensures that all particles follow the same route. The depth and angle of the grooves together with the liquid velocity were studied to provide optimum geometry of a chip.

Moreover, it was shown that when laminar co-flows are introduced into the channel that contains groove at the bottom, with the angle #0°, three different behaviors of liquid (called regimes) are observed depending on the groove's depth and liquid velocity. Regime 1: the liquid that is present above the groove is also present inside the groove when the latest is on its trajectory. Regime 2: only one liquid invades the entire groove. Regime 3: liquids above the groove mix themselves. Only the characteristics of Regime 1 are suitable for LbL coating of particles using the groove guided method.

The functionality of the device by coating on chip the particles with two bilayers (four sublayers) was confirmed by fluorescent microscopy. All 7 steps, that in batch require multiple manipulation of particles, here were possible in one device and took about one minute. It is worth to mention that the time particles were exposed to each of the coating solutions and the washing solution was short (a dozen of seconds) and efficient. It is possible that the facts that the liquid is continuously refreshed inside the groove and particles both: slide and rotate while moving, helps for efficient particles coating. This again shows an advantage of performing LbL on chip.

For the sake of completeness, information on how the fluid velocity profile is determined in the above example is shown below. The fluid velocity in a channel with a rectangular cross-section where one side is much larger than the other one, h>>w, is related to the coordinate y by a simple analytical expression:

$$v ( y ) = \frac{Δ p}{2 μ L} \cdot ( \frac{{w}^{2}}{4} - {y}^{2} ) , \qquad ( 2 )$$

where Δp is the pressure drop between the opposite sides of the channel, μ is the dynamic viscosity of the fluid, L is the length of the channel, and w is the height of the channel in the y-direction.

The fluid velocity can be calculated directly from Eq. (2). However, we know the average velocity of the fluid, <v>, measured experimentally, and therefore it is useful to express v(y) via this quantity. The average velocity can be calculated by integrating Eq. (2) along the height, from −w/2 to w/2, and dividing by w, resulting in:

$$< v > = \frac{Δ p}{2 μ L} \frac{{w}^{2}}{6} \qquad ( 3 )$$

$$and$$

$$v ( y ) = \frac{6 < v >}{{w}^{2}} ( \frac{{w}^{2}}{4} - {y}^{2} ) . \qquad ( 4 )$$

This result, Eq. (4), is valid for a channel with a rectangular cross-section where the width is much larger than height, h>>w, and the maximum value,

$${v}_{max} = \frac{3}{2} < v > \qquad ( 5 )$$

is achieved along the line y=0.

The chip has a rectangular cross-section with comparable width and height, 4 mm×1 mm. Therefore, it is reasonable to assume that the fluid velocity profile is parabolic in both directions, in the x- (width) and y-direction (height), and the maximum velocity is achieved at one point (x=0, y=0). This means that Vmax in Eq. (5) becomes a function of x, and its average, <vₘₐₓ(x)>, is related with vₘₐₓ(x=0) via the same relation as <v> and vₘₐₓ in Eq. (5):

$${v}_{max} = \frac{3}{2} < {v}_{max} ( x ) > = \frac{9}{4} < v > . \qquad ( 6 )$$

Thus, the average velocity in a channel with parabolic velocity profile in both directions is ⅔ of its value for a channel with infinite width [Eqs. (2)-(4)]. Therefore, in order to evaluate fluid velocity v(y) for x≈0, the right-hand side of Eq. (4) should be corrected by a factor of 3/2.

Thus, for a particle of diameter of 89 mm, the fluid velocity at the level of the center of the particle is approximately

$$v ( y = \frac{w}{2} - r ) = 0.2 < v > . \qquad ( 7 )$$

This analytical result is also consistent with the estimate of the fluid velocity profile found from COMSOL simulations.

Inside the groove, the flow can be approximately considered as a Couette flow, being top layer driven by the flow near the bottom of the chip and having zero velocity at the bottom of the groove. Therefore, the fluid velocity further decreases in the groove, and for a particle 89 mm in a groove of about 100 μm deep, the velocity is estimated as ≈0.1 of the average value in the chip.

Further by way of illustration, in a second example, Particle stability in the grooves was studied and improved by varying groove/particle dimensions and groove angle allowing for trajectory flexibility and reduced footprint. The stream integrity was studied by introducing different type of walls. Summarized above improvements, together with using the turn in chip design leads to realizing large numbers of cycles withing one chip.

All chips in the present example were made inhouse and designed with SolidWorks and AutoCAD They were made of PMMA by milling (high speed CNC milling machine, Datron Neo, Datron AG., Germany). Chips were made of two or three parts that were assembled and bonded inhouse with the use of butyl lactate that was introduced by the capillary force between the layers of the chip [Gelin 2020]. Profilometer (Filmetrics Profilm 3D) was used to determinate the depth of the grooves. Liquid (ethanol) was introduced to the chip via glass capillaries (ID 450 μm, OD 670 μm, Polymicro, Achrom) that were glued to the chip inlets and outlets. In all experiment that particles were not used, the liquids were introduced with the help of syringe pumps. In a case of experiments involving suspension on particles, pressurized pumps (Fluigent) and Vortex were used to prevent sedimentation of particles to the bottom of the Falcon tube. In that case the flow rate was calculated by measuring the time of collecting the determined volume of liquid at the outlet.

Technical grade ethanol was chosen to study liquid behavior in the chips because of multiple reasons, with the most important one that it is an excellent solvent for many chemicals. Ethanol can be colored with the use of commercial dyes what helps to visualize the flow. Ethanol is compatible with PMMA for moderate use of time (very long exposure of PMMA to ethanol causes cracks to material), which allowed us to test different geometry of prototype chip. Moreover, it wets PMMA which helps removal of gas bubbles and prevents particles to sticks to the surface. Patent blue (Aldrich) was used as a colorant to visualize the flows in chip.

Three different diameter sizes of polystyrene paramagnetic particle were used in the present example: 89 μm (PS-MAG-AR110, SD=1.2 μm, Iron oxide=10%, Microparticles GmbH), 67.4 μm (PS-MAG-S2303, SD=0.9 μm, Iron oxide >10%, Microparticles GmbH) and 41.13 μm (PS-MAG-S1986, SD-0.76 μm, Iron oxide >25%, Microparticles GmbH).

To achieve large number of cycles it was needed to use more of groove zig-zag motif. This could be implemented by: increasing the length of the chip or by increasing the angle of the groove. The first solution required prevention of liquid mixing by diffusion on the long distance. This could be done by introducing the walls in the chip design. The second solution required that particles follow the groove of increased angle.

The present example illustrates effects of the design of a system allowing particles to pass from one liquid phase to another in a very controlled and reproducible manner. This is possible in continuous microfluidics where multiple liquids can flow parallel to each other. Avoiding mixing of flows is highly desired, e.g. for LbL coating. The hydrodynamic flow inside microfluidics is generally laminar but sometimes vortices can be present already at low Reynolds numbers. This can happen in T-junctions where two miscible liquids enter the channel at 180° in order to flow perpendicular in the same channel further on. The vortices are even more promoted in T-junctions at higher Reynolds number. For that reason, T-junctions should be avoided to prevent mixing, and Y-junctions are recommended. Another problem encountered is diffusion.

Indeed, even in the absence of a flow, Brownian diffusion leads to the mixing of the fluid and particles across the channel.

Two liquids that meet in microfluidic channel can flow as dispersed liquids (droplets in continuous liquid) or non-dispersed liquids (e.g., parallel flow). The latter one is only stable at high velocities (e.g., in a few hundred diameter open channels flow rate should be >˜4 ml/min). At lower flow rates, the parallel flow is not stable, and dispersive flow patterns are observed.

A stable parallel flow is obtained when the viscous forces are stronger than the interfacial forces (Eq. 8). Usually, it is represented by their ratio: the capillary number (Ca) (Eq. 9):

$$viscous forces = u μ d \qquad ( 8 )$$

$$interfacial forces = γ d \qquad ( 9 )$$

$$Ca = u μ / γ \qquad ( 10 )$$

where u is the velocity, μ the dynamic viscosity, d the channel diameter and γ the surface or interfacial tension.

It is important to note, that there is no critical value of the capillary number that define where the transition is between dispersed liquids and non-dispersed liquids flow regime as the geometry of the channels also plays an important role.

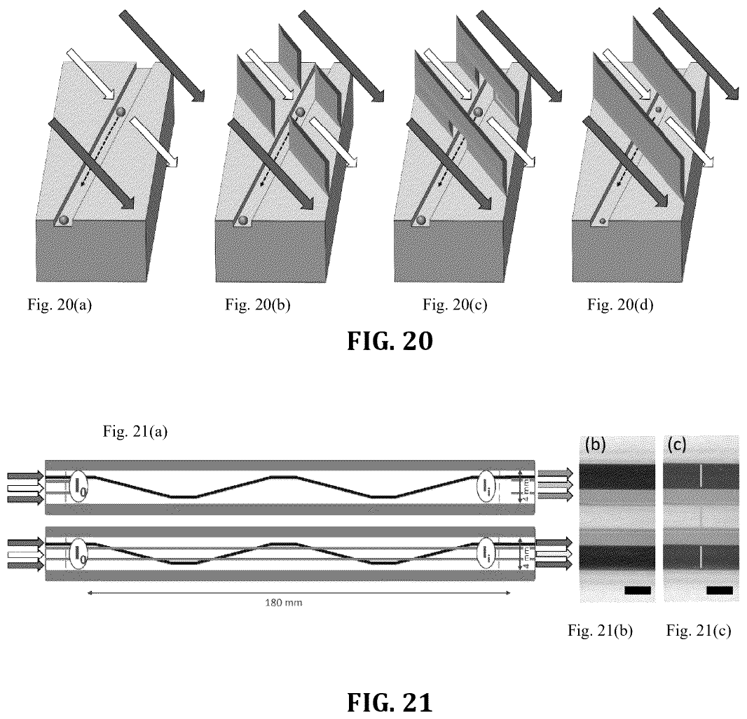

In the present example, four possibilities were identified of bringing co-flow liquids together in groove-chip with the use or no use of walls. These are presented in FIG. 20: no walls (a), discontinuous walls (b), walls with openings (c) and continuous walls (d). In the fourth case the contact between the liquids, or more practical, the possibility of particle travel is assured by presence of groove below the wall. Naturally the particle diameter must be lower than the depth of the groove.

The chips were designed in order to provide a comparable environment to study co-flow behavior in microfluidic chip depending on the absence or presence of the walls and the type of the wall. The scheme of the chips is presented in FIG. 21a. All chips have the same dimension: the length 20 cm (1 cm inlet, 1 cm outlet and 18 cm main channel), height of the channel 1 mm, width of the main channel 4 mm. In case of the chips with walls the main channel was divided into three 1 mm-wide each channel because of the presence of two 0.5 mm wide walls. The chip without walls is made of three layers: a bottom layer with groove, a middle layer with side walls and a top layer (couverture). Chips with walls are made of two layers. The bottom layer always contains ingrooved zig-zag groove. The top layer contains the side walls and the top wall. Designing and milling the walls that separate the flow is challenging because they have to be aligned with the groove but milling operation can be only done from the top surface of the part to its bottom. That is why once walls are milled on bottom (discontinuous walls) and in the other case on the top layer (continuous walls, walls with openings). The width of the groove is 300 μm and the depth of the groove is 100 μm. Only in case of chip with continuous walls the groove is 300 μm because grooves with lower depth occurred to be closed after bonding the layers.

For the experiments with particles, chips without the walls with the zig-zag groove of multiple angles from 0° to 90° were milled with three different groove depths: 53±7, 75±7 and 130±7 μm.

Ethanol was flowing through each of three inlets separately into the main channel of the chip. The side streams were colored with blue dye to visualize the flow. The middle stream was pure ethanol, see FIG. 21(a). The flow rate of all three liquids was controlled with a syringe pump. Depending on the set of experiments, the three streams were introduced at the same flow rate, or the flow rate of the side liquids were fixed, and middle flow rate was varied. The range of flow rates is ranging from 40 to 240 mL/h with corresponding linear liquid velocities of 11.1 (8.3 chip without walls) to 66.6 (49.8 chip without walls) mm/s. The liquid velocities in chip without walls were slightly lower because the cross section of the channel was bigger due to the lack of walls. The same width was kept for all chips as it was more comparable using a same geometry of zig-zag groove. Note that these values refer to average liquid velocities in the chip. The liquid velocity is maximal at the central part of the flow and decreases to zero at the boundary. The flow is a laminar flow with Reynolds number <1000; Reynolds number (L=1 mm, d=789 kg/m3) is 73.5 for liquid velocity 25 mm/s.

The integrity of the introduced liquids was measured by analyzing the presence of the blue dye in all the flows at the end of the chip and compared with those at the beginning of the chip. A photo of the end of the chip was taken at the same position. The color picture (see FIG. 21b) was converted to 8-bit picture (see FIG. 21c). The gray scale was measured along the line indicated on FIG. 21(c) for each channel using ImageJ. The value X of the grey scale was calculated for each pixel, where X=255 is white and X=0 is black. The difference in the color intensity at the beginning of the chip I₀ and its end Iᵢ was analysed. This difference is represented as a Separation index, S.

$$S = 1 - \frac{\sum \vert \frac{{I}_{o , i}}{{I}_{o , ∞}} - \frac{{I}_{i}}{{I}_{i , ∞}} \vert}{\sum \vert \frac{{I}_{o , i}}{{I}_{o , ∞}} - 1 \vert} . \qquad ( 11 )$$

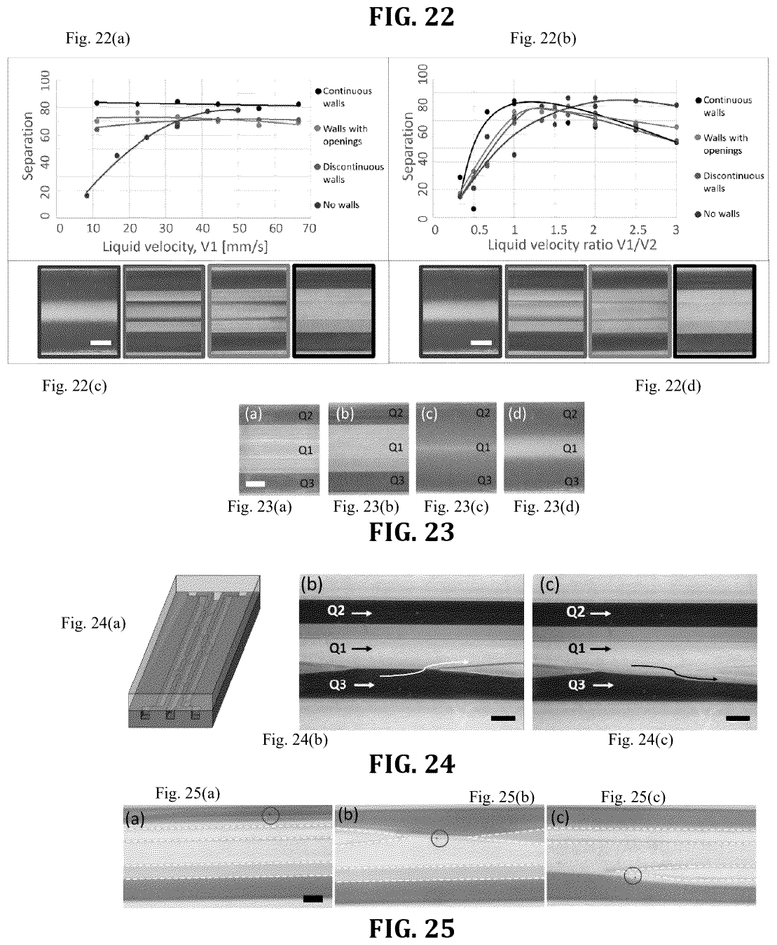

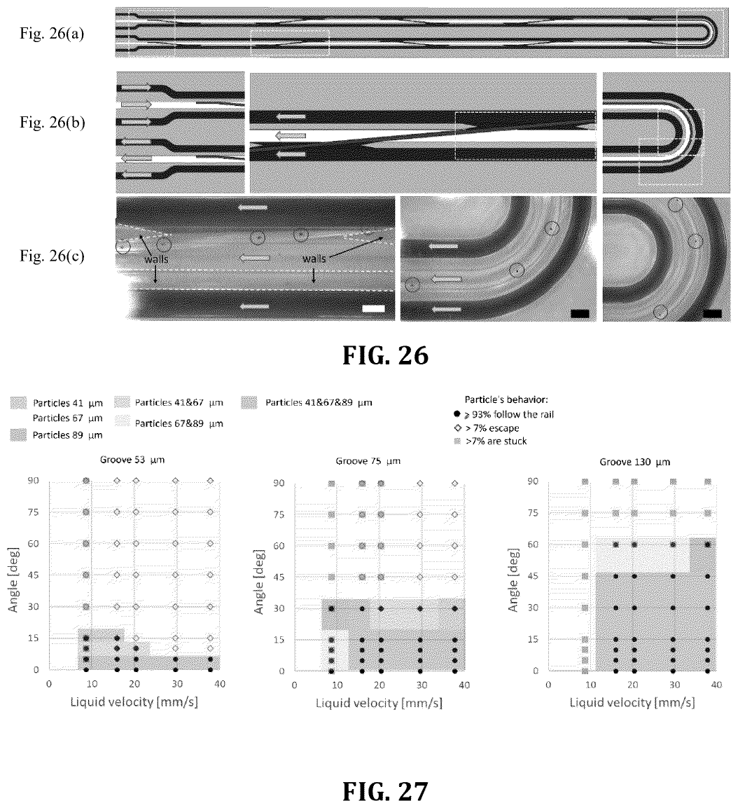

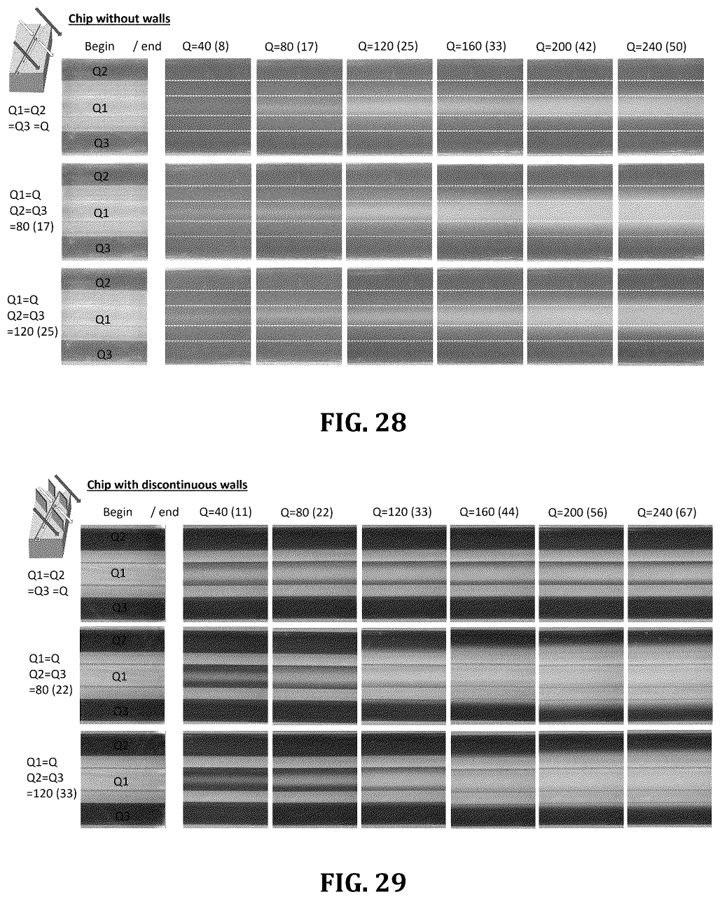

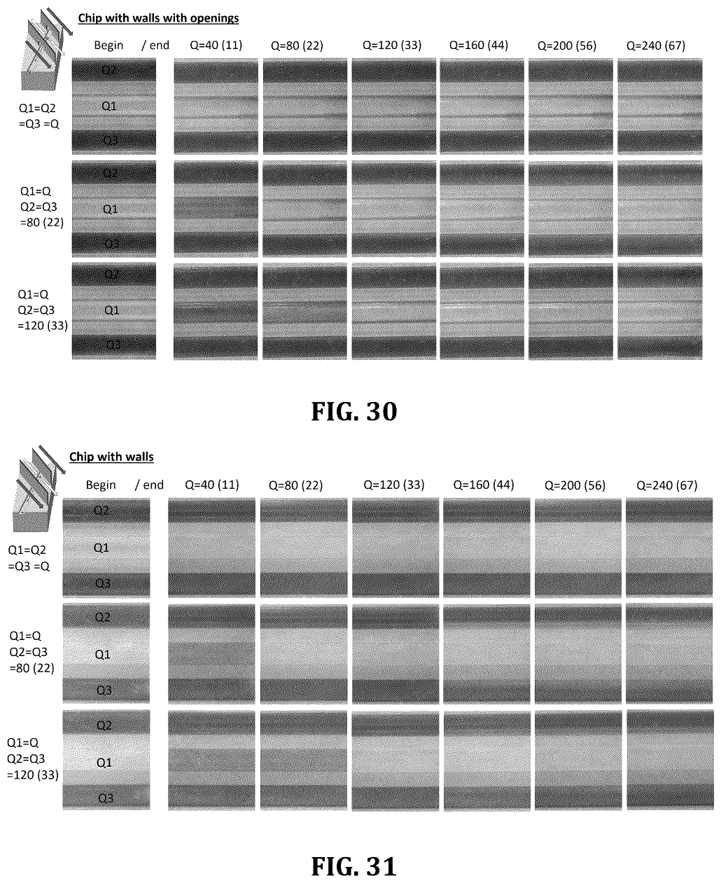

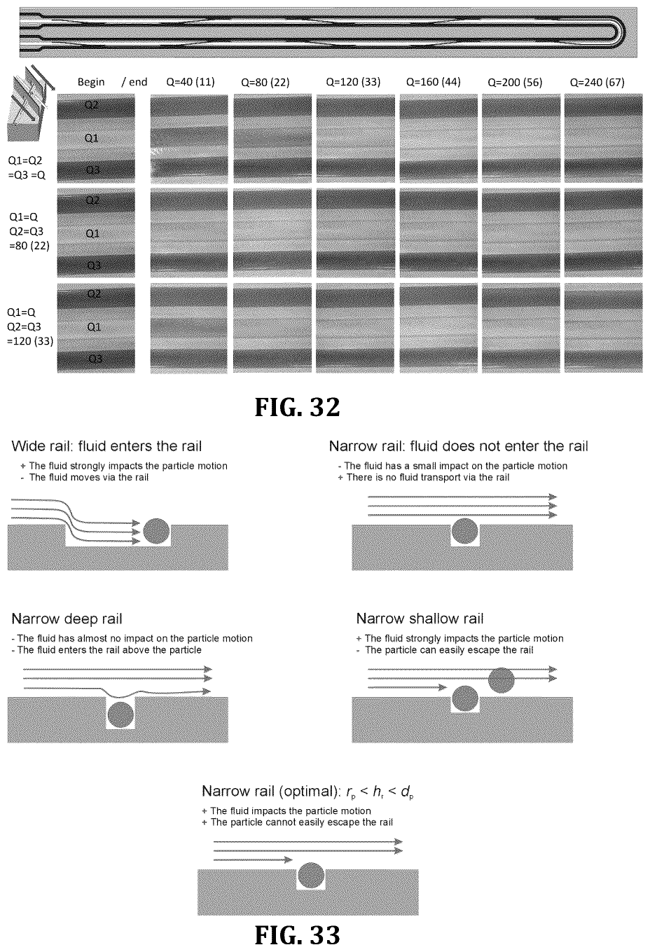

Separation index S is dimensionless. S value=1 means that the blue dye was conserved in its original channel and is not detected in the central channel, S value=0 indicates that blue dye is equally present in all the channels. The I_{0,∞} and I_{i,∞} was the average value of the intensity at the beginning and the end of the chip, respectively. The average value of I_{0,∞} and I_{i,∞} was calculated from X values along three lines perpendicular to three channels together. FIG. 22 presents Separation as a function of introduced middle liquid velocity V1, and the velocities of all introduced liquids were equal, V1=V2=V3 (FIG. 22(a)), and as a function of the velocity ratio V1 to V2, and V2=V3 (FIG. Y3(c)). There was a particular trend observed for each of the chip that is visualized by eye-guide lines.

When all liquids were introduced at the same velocity (˜flow rate) (FIG. 22(a)) the highest values of S were observed for the chip with continuous walls for all range of the velocities (flow rates). Chips with walls with openings and with discontinuous walls showed slightly lower values of S for the same range of velocities (flow rates) and appeared to be equally efficient. In the case of the chip without walls the S values highly depended on the liquid velocity. At low velocity S was low and it drastically increased with increasing the flow velocity. This was due to the diffusions that was more visible when retention time was higher (see FIG. 23(c)) and less visible when liquids travel faster through the chip (see FIG. 23(d)).

A different trend was observed when the middle liquid was introduced at a different flow rate than the side liquids. Two series of experiment were performed where side liquids were kept at the constant flow rate (Q2=Q3): 80 mL/h (series 1) and 120 mL/h (series 2) and where the flow rate of the middle liquid (Q1=Q) was changed from 40 mL/h to 240 mL/h. The S value depended on the ratio of Q1 to Q2. In case of each chip there was observed an optimum flow rate ratio that was represented by the highest S value. All chips had low S value for Q1/Q2<1. The chip with continuous walls showed the best performance at the equal flow rates, while chips with walls with openings and with discontinuous walls had the highest S values for the Q1/Q2 flow rate ratio between 1 and 2. The S value for the chip without walls increased with increasing Q1/Q2.

The pictures of the end of each chip at the conditions that scored the highest S value are presented in FIG. 22(b) and FIG. 22(d).

It is important to mention that all S calculations for the chip without walls were done analogically to those for chips with walls. This means, that the regions on the chip's end pictures, where for other chips walls were present (see FIG. 28), were excluded from the calculation. It is because for those Iᵢ values the reference I₀ values are on the walls in chip's begin pictures.

Below optimal conditions for each chip are described to keep liquids separated and at the same be functional for particles transport on the zig-zag groove.

Chip without Walls

When the liquids were introduced at the low flow rate the blue color of the dye was visible in the whole cross section of the channel, which is, also in middle stream near to the inlet. Increasing the flow rates lead to better separation of the blue dye. The best conservation of the blue color in the side streams was observed in case when the flow rate of the middle (transparent) liquid was 2.5-3 times higher than the flow rate of the side streams. The blue dye was transported to the middle of the stream due to diffusion. Effect of diffusion increased with decreasing of liquid velocity and/or increasing the distance from the beginning of the chip.

The diffusion time of the blue dye molecules from the side streams toward the center of the channel could be estimated from the Einstein diffusion law:

$$t = {x}^{2} / 2 D , \qquad ( 12 )$$

where t is the time of diffusion, x is the distance, and D is the diffusion coefficient (for molecules like Patent blue M=582.66 g/mol, it is estimated as D=5×10⁻⁶ cm²/s).

When three liquids were introduced in the chip at 80 mL/h (Q1=Q2=Q3, 1.6 mm/h), see FIG. 23(c), it was observed that at the end of the chip (18 cm from the beginning) that the blue dye was present almost at the whole cross section of the channel (in the y-direction). The liquid at the velocity of 1.6 mm/s travelled the length of 18 cm (in the x-direction) within 11 s. At the same time (11 s), the diffusion into the middle of the channel (in the y-direction) was 105 μm, according to Eq. (12). Therefore, molecular diffusion predicted a very small spread of the concentration step of the dye from the side streams to the middle of the channel and cannot explain, why fast mixing in that microfluidic channel was observed.

In a moving fluid, diffusion is enhanced by the Taylor-Aris dispersion. The resulting effective diffusion coefficient D_{eff} can be orders of magnitude larger than D. Thus, for D=5×10⁻6 cm²/s, the fluid velocity v=1.6 mm/s, and the smallest dimension of the channel (height) h=1 mm, D_{eff}≈5×10⁴ D. However, the Taylor-Aris dispersion corresponds to the long-time limit, for a channel (with circular cross-section) with a length/much longer then the radius of the channel a: l>>a. In the present example, the channel was not long enough, and the Taylor-Aris dispersion could only be considered as an asymptotic limit. Furthermore, the channel had a rectangular profile. The spread of the concentration profile, defined at the initial time t=0 by a step function at x=0 (where the concentration is maximum for x<0 and drops to zero for x>0, as the concentration of the blue dye at the border of the side streams), is described by the complementary error function:

$$c ( x , t > 0 ) = {c}_{0} erfc ( \frac{x}{\sqrt{4 Dt}} ) , \qquad ( 13 )$$

$$where$$

$$erfc ( s ) = \frac{2}{\sqrt{π}} {\int }_{s}^{∞} {e}^{- {u}^{2}} du . \qquad ( 14 )$$

Particles could follow the zigzag groove. When working with non-equal flow rates one has to remember that velocity in the channel has a parabolic profile which means the flow at the sides is lower than in the middle. Increasing the middle flow rate cause higher velocity than expected and cause escape of the particle from the groove.

Chip with Discontinuous Walls

Introducing the walls to the co-flow system to separate flows should directly solve the problem of the diffusion and allow to coexistence of the flows on the long distance. Nevertheless, in this case the contact between the liquids was ensured due to the breaks between walls. At that place two liquids meet and always one of them is invading the channel of the other liquid, as seen in FIG. 24. The ideal situation would be that no liquid invades the trajectory of the other but this is not the case. The invasion can be kept at the minimum when the flows are optimized. The experiments showed that the optimum condition is when the flow rate of the middle liquid is 1-2 times higher than the flow rates of the side flows.

Here it is important to remember about the function of the chip, which is the transport of the round particle on the zigzag groove from one side of the chip to another and back. Too high ratio of middle flow rate to side flow rate will cause particles to push to the side of the chip and prevent their travel to the middle. It was tested that the ration of 1.5-2 (middle to side liquid) does not cause a problem and is optimum for the chip with discontinuous walls (see FIG. 25 and FIG. 29).

Chip with Walls with Openings

This chip was similar to the chip with discontinuous walls, but the difference was that the area where the liquid meets was smaller because the walls were continuous from the top side of the channel. The manufacture of this chip was more challenging because the walls had to be milled on the top layer of the chip and then aligned with the groove that is on the bottom layer. The alignment was not as straightforward as in the case of chip with discontinuous walls where the groove and the walls are directly milled on the same part of the chip (bottom).

When three liquids were introduced at the equal flow rate, the preservation of the color inside channels was good for all range of tested flow rates (see FIG. 30). When the flow rates between middle liquid and side liquids were varied, invasion of the liquid with the higher flow rate to the channel with the lower flow rate was observed. The optimum conditions were when the flow rate of the middle liquid was 1 to 2 times higher than the side stream. The particles could follow the zigzag groove at those flow rate conditions.

Chip with the Turn

The chip with walls with openings was considered as the best type of all four chips and that is why its design was further adapted to manufacture two times longer chip containing additionally a turn as can be seen in FIG. 26 and FIG. 32. All behavior of the 20 cm long chip was preserved in 40 cm long chip containing the turn, as well as its functionality. Particles were able to travel through all the groove under the same condition as in 20 cm long chip.

Chip with Continuous Walls

The results (FIG. 31) are presented for the groove of depth 300 μm because grooves of lower depth turned out to be always blocked after the assembly and bonding of the chip. This chip showed the best conservation of the blue color in the side channels for every flow rate when the flow rates are equal.

For non-equal flow rate, the liquid with the higher flow rate invades the other channel. It is remarkable that-when introducing particles to the chip-particles could follow the groove only when all flow rates were the same. In other cases, the particles were stopped at the wall (bellow the wall) and could not enter the channel with the higher flow rate ratio.

Repetition of the zig-zag groove naturally forced to increase the chip length. The extension in the x direction could be tuned by manipulation with the groove angle at the zig part and the length of zag part. Let's assume that zag part (with) 0° is constant. For a one part of groove that crosses 3 liquids in the y direction of the chip withing the distance 3.5 mm the change of angle from 5° to 30° results in decreasing the length of 34.5 mm in x direction. This means that in chip designed for 5 bilayer coating (10 times groove with angle) change in angle from 5 to 30° would result in decrease of the chip length of 34.5 cm.

| Groove angle | 5° | 10° | 15° | 30° |
|---|---|---|---|---|
| Length of groove in X direction for | 40.53 | 20.11 | 13.02 | 6.04 |
| 3.5 mm in Y direction [mm] | | | | |
| Gain in X direction when 1 groove | 0 | 20.42 | 27.51 | 34.49 |
| [mm] | | | | |
| Gain in X direction when 10 | 0 | 20.42 | 27.51 | 34.49 |
| grooves[cm] | | | | |

The length of the 0° groove was also very important because together with the liquid flow rate it defined the time length available for the coating. Here it was assumed that the reaction is fast and does not require specific minimum time of reaction. In other cases, it should be taken under consideration that a particle traveling the groove at the angle 5° will spend more time in the coating solution that a particle traveling in a 30° groove and this could give a possibility to decrease the length of 0° groove.

Not every particle could follow every groove. This is limited by the depth of the groove, the angle of the groove and the velocity of the particle. Velocity of the particles results from the flow rate of the liquid and the particle position inside the groove. A series of the experiment were performed with particles of the diameter 41.13, 67.4 and 89.0 μm. Particles' suspension and two other liquids were introduced with a pressurized pumps (Fluigent). The flow rate of the liquids was calculated after the measuring the time needed for collecting precise volume of the liquid at the outlet. Each type of particles was introduced to the chip with the groove of depth of 53 μm with the angle from 0° to 90°. The same experiments were performed in the chips with the depth of groove 75 and 130 μm. The stability of the particles on the groove was observed (see FIG. 27). Three types of behavior were seen: particles following the groove, particles escaping the groove or particles getting stuck in the groove. It was concluded that particles were able to follow the groove when 100% of the same size particles were following the groove, to ensure equal coating of all particles in optimized chip.

First, the behavior of the particles in two extreme depths of the groove was analysed.

In the chip with lowest groove depth: 53 μm, 4 regions were observed (see FIG. 27(a)): light gray—where fractions of particles of each type do not follow the grooves, violet—where all particles follow the groove, green—100% of particles of size 41 and 67 μm follow the groove and blue—only 41 μm follow the groove. The trend was observed: with increasement of liquid velocity and groove's angle less and less particles follow the groove. It is due to the fact that first escape the biggest particles (89 μm) and then the middle size particles (67 μm) that are not stabilized by the small depth of the groove. In general: particles were following the groove or escaping the groove, only at very low flow rate some particles were stuck in the groove.

In the chip with highest groove depth: 130 μm the 4 regions (see FIG. 27(c) were also observed: light gray—where fractions of particles of each type did not follow the grooves, violet—where all particles followed the groove, orange—100% of particles of size 67 and 89 μm followed the groove and red—only 98 μm followed the groove. The same trend was again observed: with increasement of liquid velocity and groove's angle less and less particles followed the groove. This time, the bigger particles follow the groove at broader conditions. The depth of the groove was bigger than the diameter of all tested particles which imply that particles did not escape the groove. Now, particles either follow the groove or get stuck in the groove. The bigger particles had higher velocity because they were pushed by the liquid with higher velocity (liquid velocity drastically decreases from the top to the bottom of the groove) and this makes them less prone to stuck.

The behavior of the particles in middle depth of the groove was analysed because it represented the mix of two extreme cases. All three types of particles behavior was observed: they followed the groove, escaped the groove and got stuck. At very low flow rate (<10 mL/h) particles had tendency to get stuck. A fraction of the slowest (=smallest) particles got stuck. Only the particles with a sufficient velocity were able to follow the groove. With the increment of the groove angle first particles of lower velocity (67 μm) got stuck and finally at the angle of 45° the 130 μm diameter particles also got stuck. At the velocity between 16 and 40 mL/h and groove angle up to 15° all particles followed the groove. Above that angle, particles had the tendency to escape the groove: first the biggest particles that were not stabilized by depth of the groove escaped and then the middle and the small diameter particles escaped.

The present example illustrates that the main influence on particles stability was caused by the depth of the groove. It had a bigger impact than the groove angle. At low groove depth the biggest problem is that particles are escaping from the groove, while in high depth particles are getting stuck in the groove. The grooves angles that secure particles' travel are 0° and 5°. Choosing the optimal particles size and groove depth, the groove angle can be drastically increased still ensuring particle stability on the groove. It was observed that 100% of particles of 89 μm diameter can follow the groove of the depth 130 μm and 60° angle at liquid flow rates range from 16 to 40 mL/h.

By way of illustration, embodiments of the present invention not being limited thereto, some further examples are given below.

According to at least some embodiments of the present invention, the guiding groove advantageously is a narrow groove with a depth ranging between the radius and the diameter of the particle for which the device is intended to be used. Such guiding grooves may be especially efficient for guiding particles and at the same time may be especially suited for avoiding undesired fluid mixing by transporting it via the grooves.

According to some embodiments, the height of the channel advantageously is larger than the height of the groove. It is to be noted that the efficiency of the guidance depends on the velocity of the fluid in the channel near the groove. Therefore, in very deep channels the velocity near the groove could be considerable smaller than in the central flow region. From this consideration, the channel advantageously should not be too deep for optimal guidance.

The width of the guiding groove effects the amount of the fluid entering the guidance groove. If the guidance groove is very wide, e.g. much wider than the diameter of the particle, Regime 1 will be realized when the velocity of the fluid inside the groove is strongly correlated with or nearly equal to that in the main channel. In this case, the flow velocity in the groove will simply relate to cos (a), where a is the angle between the direction of the channel and the direction of the groove. This regime would provide the maximal velocity of the particle, which will correlate with cos (a) reduced by the wall effects). However, this regime (of very wide groove) is associated with strong flow of fluid inside the groove, which may be an undesirable effect and therefore may be avoided. Therefore, very wide grooves are not optimal. On the other hand, the width of the groove is limited by the particle diameter: it should be larger than the particle diameter to let the particle accommodate itself and move inside the groove. In the case of a very narrow groove, e.g. slightly wider than the diameter of the particle, only the fraction of the fluid above the particle will be influenced by the moving fluid in the main channel. This guarantees the minimal penetration and transport of the fluid via the groove (which is desirable). It can be easily understood that in this case (of extremely narrow groove) the fluid transport via the groove could be completely excluded when the depth of the groove is a half of the diameter of the particle. In this extreme case (the width of the groove is slightly larger than the diameter of the particle, and the depth of the groove is slightly larger than the radius of the particle), the guidance effect is expected to be the optimal. Also, the penetration of the fluid inside the groove will be minimal. However, in this case the motion of the particle would be affected by fluctuations of the width and by roughness of the groove surface as well as by related hydrodynamic effects, which would make the motion of the particle unstable and could easily lead to the escape of the particle from the groove.

By way of illustration, examples of flow regimes for different guidance groove channel parameters are shown in FIG. 33.

It is to be understood that although preferred embodiments, specific constructions and configurations, as well as materials, have been discussed herein for devices according to the present invention, various changes or modifications in form and detail may be made without departing from the scope of this invention. For example, any formulas given above are merely representative of procedures that may be used. Steps may be added or deleted to methods described within the scope of the present invention.

1.-14. (canceled)

15. A microfluidic device for allowing particles to interact with a plurality of liquids, the microfluidic device comprising:
a microfluidic channel having a bottom wall,
a plurality of inlets for introducing the plurality of liquids in the microfluidic channel so as to create a plurality of parallel fluid flows in the microfluidic channel along a flow direction,
an inlet for Introducing dispensed particles in the microfluidic channel, and
a particle guiding groove in the bottom wall of the microfluidic channel for inducing lateral movement of the particles so that the particles are guided laterally by the particle guiding groove with respect to the average flow direction in the microchannel, so that the particles are guided through different liquids of the plurality of liquids.

16. The microfluidic device according to claim 15, the microfluidic device being configured for having predetermined minimum flow rates of the plurality of liquids, and
wherein the groove has a rectangular cross-section having a groove height, the predetermined minimum flow rates and the groove height being selected so as to induce a flow regime of the fluids such that, for each position along the particle guiding groove, the fluid in the particle guiding groove is the same as the fluid that is present above that position of the particle guiding groove.

17. The microfluidic device according to claim 16, wherein the groove has a width of at least 300 μm and the height of the microfluidic channel is at least 1 mm, and
wherein the groove height is smaller than 150 μm.

18. The microfluidic device according to claim 16, wherein the device is intended for allowing particles having an average diameter d interact with the plurality of fluids, and
wherein the device has one, more or all of a groove width being at least 5 times the average diameter d and a depth of at least ⅓ times the average diameter d or a depth of at least ½ times the average diameter d.

19. The microfluidic device according to claim 16, the microfluidic device being configured for operating with particles having an average size d and with predetermined liquid flow rates,
wherein the maximum angle made by the particle guiding groove with respect to the average flow direction is selected so as to avoid particles from leaving the particle guiding groove, taking into account the average particle size used, the liquid flow rates used and the groove height of the particle guiding groove.

20. The microfluidic device according to claim 15, wherein walls are provided between the different fluids in order to reduce or avoid mixing of the parallel fluid flows.

21. The microfluidic device according to claim 20, wherein the walls are discontinuous at positions where they pass the guiding groove,
wherein the walls have recesses at positions where they pass the guiding groove or
wherein the walls are continuous near positions where they pass the guiding groove.

22. The microfluidic device according to claim 15, wherein aside the particle guiding groove an array of pillars or an additional guiding groove is positioned.

23. A method for allowing particles to interact with a plurality of liquids, the method comprising:
introducing the plurality of liquids in a microfluidic channel so as to create a plurality of parallel fluid flows in the microfluidic channel,
introducing dispensed particles in the microfluidic channel, and
inducing lateral movement of the particles so that the particles are guided laterally with respect to the average flow direction in the microchannel, so that the particles are guided through different liquids of the plurality of liquids.

24. The method according to claim 23, wherein introducing the plurality of liquids comprises introducing the plurality of liquids such that they flow in parallel fluid flows at flow rates at or above 15 mm/s, for each of the different liquid flows.

25. The method according to claim 23, the method being intended for allowing particles having an average diameter d to interact with the plurality of liquids, and the method comprising inducing lateral movement of the particles using a groove having a groove width being at least 5 times the average diameter d and a groove depth of at least ⅓ times the average diameter d or a depth of at least ½ times the average diameter d.

26. The method according to claim 23, wherein the method furthermore comprises keeping the different fluids separated using walls.

27. The method according to claim 23, wherein introducing dispensed particles in the microfluidic channel comprises guiding particles into the microfluidic channel and into a particle guiding groove for subsequently inducing said lateral movement.

28. Use of a microfluidic device according to claim 15 for allowing particles to interact with a plurality of liquids.
